(19) United States
(12) Patent Application Publication
(10) Pub. No.: US 2026/0288846 A1
(43) Pub. Date: Sep. 24, 2026

(54) SYSTEM

(71) Applicant: SoftBank Group Corp., Tokyo (JP)

(72) Inventor: Yu KAZUMI, Tokyo (JP)

(73) Assignee: SoftBank Group Corp., Tokyo (JP)

(21) Appl. No.: 19/568,901

(22) Filed: Mar. 17, 2026

(30) Foreign Application Priority Data
Mar. 19, 2025 (JP) 2025-045183

(51) Int. Cl. G06F 16/34; G06F 16/31; G06F 40/103; G06F 40/166; G06F 40/205; G06F 40/284; G06F 40/30; G06F 40/40; G06N 3/0475; H04L 9/40

(52) U.S. Cl. CPC G06F 16/345; G06F 16/313; G06F 40/103; G06F 40/166; G06F 40/205; G06F 40/284; G06F 40/30; G06F 40/40; G06N 3/0475; H04L 63/10

(57) ABSTRACT

A system includes a processor that is configured to receive information from a user and analyze content of the information by using a generative AI model to extract key points, summarize the extracted key points by using a natural language processing technique based on a prompt that instructs summarization of the key points, and store the summarized key points in a cloud storage in a format that is referable.

### CROSS-REFERENCE TO RELATED APPLICATION

This application is based on and claims priority under 35 USC 119 from Japanese Patent Application No. 2025-045183 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional communication support systems, a processor typically stores raw or minimally processed user input such as text logs, messages, or notes. When a user or another stakeholder later needs to understand the essential points of past communications, the user is required to manually read through large amounts of information and to manually identify and summarize important content. This causes a burden in terms of time and cognitive load, and makes it difficult to quickly grasp the current status of a project or discussion.

Furthermore, conventional systems generally do not utilize a generative AI model to automatically extract and summarize key points from arbitrary user input in a flexible and context-aware manner. Existing summarization functions, when present, are often based on fixed templates or simple keyword extraction, and thus may fail to capture nuanced decisions, action items, or implicit priorities contained in the user's information.

In addition, conventional systems typically do not analyze user emotion in an integrated manner together with the extracted key points. As a result, such systems cannot store and later present the emotional context along with the substantive summary of the content. This makes it difficult to understand not only what was communicated, but also how the user felt at the time, which can be important for communication management, mental health support, and relationship building.

Moreover, existing systems rarely employ a generative AI model to generate positive information tailored to a user's emotional state and to provide such positive information back to the user. Consequently, conventional systems do not actively support improvement or stabilization of the user's emotional state, and they do not offer proactive feedback or encouragement based on emotional analysis.

Therefore, there is a need for a system that: (i) automatically analyzes user information using a generative AI model to extract key points; (ii) summarizes these key points based on prompts for natural language processing and stores them in a referable format in cloud storage; (iii) analyzes the user's emotion to extract emotion data and store the emotion data together with the key points; and (iv) generates positive information based on the emotion data using a generative AI model and provides such positive information to the user through appropriate prompts.

### SUMMARY

To solve the above-described problems, according to one aspect of the present invention, there is provided a system comprising a processor, wherein the processor is configured to receive information from a user and analyze content of the information by using a generative AI model to extract key points. The processor is further configured to summarize the extracted key points by using a natural language processing technique based on a prompt that instructs summarization of the key points, and to store the summarized key points in a cloud storage in a format that is referable, thereby enabling efficient retrieval and understanding of essential information without requiring the user to manually review extensive raw data.

In some embodiments, the processor is configured to extract emotion data by using a generative AI model to analyze an emotion of the user and to store the emotion data together with the key points. By associating the emotion data with the summarized key points, the system allows later access not only to the logical content of the communication but also to the emotional context in which the content was produced, thereby supporting more comprehensive understanding of past communications and user states.

In some embodiments, the processor is configured to use the generative AI model to generate positive information based on the emotion data and to use a prompt that instructs providing the positive information to the user. By generating positive information tailored to the user's emotional condition, the system can provide feedback, encouragement, or supportive messages that are suitable for the detected emotion, thereby contributing to improvement or stabilization of the user's emotional state.

Accordingly, by employing a generative AI model both for extracting and summarizing key points and for analyzing and responding to user emotion, and by storing the resulting summaries and emotion data in a referable format in cloud storage, the system of the present invention enables automatic, context-aware summarization of user information together with emotional context and proactive provision of positive information to the user.

The term “system” refers to an arrangement including at least one processor and optionally one or more memories, storage devices, communication interfaces, and other hardware or software components that cooperate to perform the functions described in the claims.

The term “processor” refers to any hardware device or combination of hardware devices capable of executing instructions, such as a central processing unit (CPU), a graphics processing unit (GPU), a digital signal processor (DSP), an application specific integrated circuit (ASIC), a field programmable gate array (FPGA), or any other programmable logic device, including a plurality of such devices operating together.

The term “user” refers to a human or an entity that provides information to the system, receives information from the system, or interacts with the system through an input/output interface.

The term “information” refers to data provided by the user to the system, including but not limited to natural language text, voice input converted to text, images converted to text by optical character recognition, or structured or unstructured digital content that can be processed by the generative AI model.

The term “generative AI model” refers to a machine learning model or collection of models configured to generate or transform content, such as text, based on input data, including but not limited to large language models, transformer-based models, encoder-decoder models, or other neural network models capable of producing natural language output or intermediate representations.

The term “analyze” refers to processing input information by the generative AI model and/or other algorithms to derive higher-level representations, such as semantic structures, topics, entities, relationships, emotions, or other features relevant to extracting key points or emotion data.

The term “key points” refers to portions of the user-provided information, including sentences, phrases, concepts, decisions, tasks, or other elements, that are determined to be important or representative of the essential content of the information.

The term “natural language processing technique” refers to a set of algorithms, models, or methods for processing human language, including but not limited to tokenization, part-of-speech tagging, parsing, semantic analysis, summarization, text classification, or other techniques used to transform, summarize, or otherwise manipulate natural language data.

The term “prompt” refers to a text or data input provided to the generative AI model or other processing component that instructs or guides the model on how to process the information, including instructions to extract, summarize, rephrase, generate, or otherwise handle key points or positive information.

The term “summarize” refers to generating, from the key points or from the original information, a shorter or more concise representation that preserves at least a part of the essential meaning, decisions, tasks, or other important aspects of the original content.

The term “cloud storage” refers to a storage service provided over a network, in which data is stored on one or more remote servers or storage systems managed by a cloud provider or similar infrastructure, and is accessible to the system via a communication network.

The term “in a format that is referable” refers to a stored data format that can be accessed, retrieved, read, or presented by the system or by another authorized device or service at a later time, including but not limited to structured records, documents, databases, or other machine-readable formats.

The term “emotion data” refers to data representing an analysis result of the user's emotional state derived from the user's information, including but not limited to labels such as positive, negative, neutral, or more fine-grained categories, intensity scores, or other numerical or symbolic indicators of emotion.

The term “positive information” refers to content generated by the generative AI model that is intended to have a supportive, encouraging, reassuring, or otherwise beneficial effect on the user, and that is generated based at least in part on the emotion data associated with the user.

The term “provide” refers to outputting or making available information to the user through one or more interfaces, including but not limited to displaying on a screen, sending as a message, generating audio output, or otherwise communicating the information to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

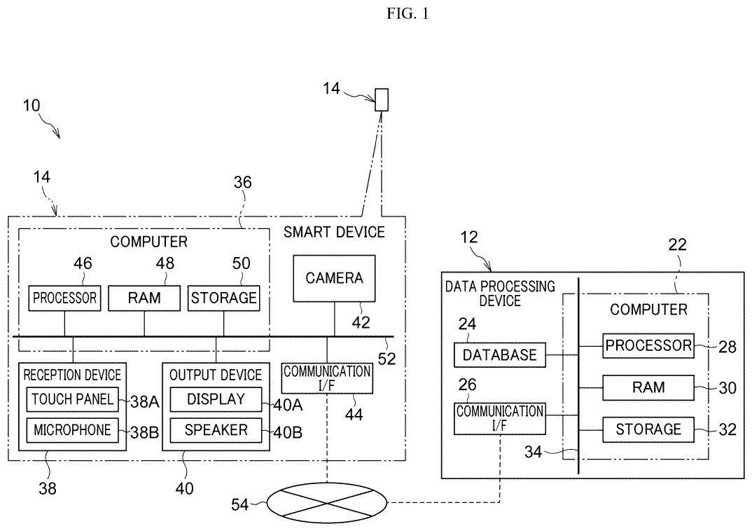

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

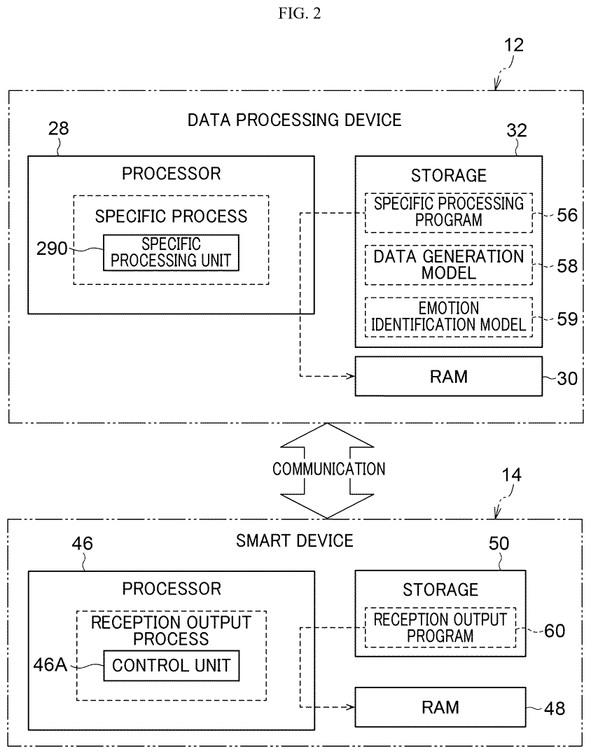

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented communication tools such as electronic mail systems, messaging platforms, and group collaboration services require users to manually browse large volumes of textual communication in order to understand the current status of an ongoing project, identify responsible persons, and recognize upcoming deadlines. Even when conventional summarization functions are provided, such functions are typically executed on a per-message basis, and are not integrated with structured extraction of key fields such as dates, actors, action items, and deadlines. As a result, users are forced to repeatedly open and read multiple messages across different devices and applications, and system resources are consumed by redundant retrieval and rendering of largely irrelevant content.

Furthermore, known systems that apply natural language processing or generative models to user communications generally treat such processing as an auxiliary content-generation feature, without integrating it into the core data flow of message ingestion, storage, structured key-point extraction, aggregation, and downstream retrieval. Such systems typically return free-form text without stable structure, which complicates further machine processing, persistent storage in network-based storage services, and efficient retrieval across devices. This limits the ability of the underlying computer system to manage communication data in a format that is both machine-tractable and human-readable, thereby failing to fully exploit available computing resources such as network storage, databases, and modern language models.

In addition, existing systems often do not leverage prompt-based orchestration of generative models as an internal control mechanism for data processing pipelines. For instance, they do not systematically use prompt sentences to drive classification, de-duplication, and formatting operations in a manner that yields standardized, reference-ready key-point records. As a consequence, server-side processing is fragmented, data structures remain heterogeneous, and the overall performance of the computer system—in terms of latency, bandwidth utilization, database indexing efficiency, and user interface responsiveness—is suboptimal.

Moreover, although sentiment analysis techniques are known, they are typically implemented as stand-alone analytics and are not tightly integrated with a unified key-point extraction and storage mechanism. Emotional information is often either discarded or presented in an ad-hoc manner, with no consistent association to corresponding key points or summaries. As a result, the computer system cannot reliably use emotional attributes as structured data for subsequent processing, such as generation of supportive or affirmative responses tailored to the detected emotional state. This leads to additional user interactions, redundant API calls, and increased cognitive load for users, all of which degrade the effectiveness of the communication management system.

Accordingly, there is a need for an improved computer-implemented system that, at the server level, (i) ingests communication information from user terminals, (ii) performs structured extraction of key points using a combination of generative models and natural language processing algorithms, (iii) orchestrates such models through explicit prompt sentences to drive aggregation, de-duplication, and formatting, (iv) stores the resulting structured summaries and associated emotional attributes in a network storage area in a reference-ready manner, and (v) generates optimized browsing screens for user terminals. Such a system should improve the functioning of the underlying computer infrastructure by reducing redundant data transfers, standardizing data formats for indexing and retrieval, and enabling more efficient use of processing and storage resources.

The specific processing by the specific processing unit 290 of the data processing device 12 in Example 1 is realized by the following means.

The present invention provides a server comprising a processor, a storage device, a network interface, and an interface to a network-based storage service, the processor being configured to receive communication information from a user terminal via the network interface and store the communication information as record information in the storage device; to analyze text information included in the record information as input information by using a generative language model in combination with a natural language processing algorithm and to extract, based on such analysis, summary information as key points including at least date information, actor information, deadline information, and action information; to aggregate the extracted summary information into reference information in a list format or a structured data format by performing classification processing, duplicate-elimination processing, and format-adjustment processing on the summary information in accordance with a prompt sentence supplied to the generative language model; to store the reference information as an electronic file in a network storage area provided by the network-based storage service and to associate, in the storage device, identification information and reference location information corresponding to the electronic file; to extract emotional attribute data representing an emotional state from the text information included in the record information by using the generative language model and to store the emotional attribute data in association with the summary information; and to generate browsing screen information, based on the identification information, the reference location information, the summary information, and the emotional attribute data, so as to allow the reference information to be presented on the user terminal, and to transmit the browsing screen information to the user terminal. This enables an improvement in the functioning of the computer system by transforming unstructured communication streams into structured, reference-ready records using prompt-driven generative processing, reducing redundant retrieval and rendering of raw messages, optimizing storage and indexing operations across local and network-based storage resources, and allowing user terminals to obtain concise, context-rich key points and associated emotional information with reduced computational and cognitive overhead.

The term “system” refers to a combination of hardware components and software components that cooperate via one or more networks to execute the functions described herein.

The term “processor” refers to one or more hardware processing units, such as a central processing unit or a graphics processing unit, capable of executing instructions to perform arithmetic and logical operations.

The term “storage device” refers to one or more hardware components configured to store digital data, such as a magnetic disk, a solid-state drive, or a semiconductor memory, including both volatile and non-volatile storage.

The term “user terminal” refers to an electronic device operated by a user, such as a smartphone, a tablet, a laptop computer, a desktop computer, or a similar computing device capable of network communication and user interaction.

The term “network interface” refers to a hardware and software component that enables the system to send data to and receive data from other devices over a communication network.

The term “communication information” refers to digital data representing content exchanged between users, including text, metadata, and related attributes of electronic messages, chats, or other communication records.

The term “record information” refers to communication information that has been stored in a structured or semi-structured form in the storage device for subsequent processing.

The term “text information” refers to the portion of the record information that comprises human-readable character sequences, such as message subjects, message bodies, or other textual fields.

The term “input information” refers to data supplied to a computational component, including a generative language model or a natural language processing algorithm, for analysis, transformation, or generation of output data.

The term “generative AI model” refers to a machine-learned model configured to generate or transform natural language or other content in response to an input, including but not limited to generative language models.

The term “natural language processing algorithm” refers to a computational method or set of methods that analyze or transform human language text, such as tokenization, parsing, entity recognition, classification, or similar operations.

The term “summary information” refers to condensed data derived from the text information that captures core content, including abstracted descriptions of events, responsibilities, and constraints.

The term “key points” refers to units of summary information representing important elements of the communication information, including but not limited to dates, actors, deadlines, and actions.

The term “date information” refers to data that represent temporal expressions, such as specific dates, times, or time periods, extracted from the text information.

The term “actor information” refers to data that identify entities responsible for actions, such as persons, groups, or roles mentioned in the communication information.

The term “deadline information” refers to data that indicate due dates or time limits associated with tasks, obligations, or deliverables described in the communication information.

The term “action information” refers to data that indicate tasks, operations, or activities to be performed, as derived from the communication information.

The term “reference information” refers to aggregated and formatted summary information and key points arranged in a manner suitable for human viewing and machine retrieval.

The term “list format” refers to a representation in which multiple key points are ordered as discrete entries, such as bullet lists or numbered lists.

The term “structured data format” refers to a representation that organizes data into predefined fields or schemas, such as key-value structures, tables, or hierarchical documents.

The term “classification processing” refers to a computational operation that assigns key points or other data to one or more categories or labels according to predetermined rules or learned models.

The term “duplicate-elimination processing” refers to a computational operation that detects and removes duplicated or substantially redundant data items among multiple key points or records.

The term “format-adjustment processing” refers to a computational operation that transforms data into a standardized or human-readable layout, including text normalization, field ordering, and formatting.

The term “prompt sentence” refers to a natural language or machine-readable instruction provided as input to a generative AI model to specify a task, constrain an output format, or guide the model's behavior.

The term “electronic file” refers to a digital object that encapsulates data in a particular format, such as a text file, a markup file, or a structured document stored in a storage medium.

The term “network storage area” refers to a logical storage region provided by a remote storage system that is accessible over a communication network.

The term “external storage service” refers to a remotely managed service that provides access to a network storage area, including interfaces for uploading, downloading, and managing electronic files.

The term “identification information” refers to data that uniquely identify an electronic file or a record, such as an identifier, a key, or a similar reference value.

The term “reference location information” refers to data that specify a location of an electronic file or a record within a storage system, such as a path, a URL, or a similar locator.

The term “browsing screen information” refers to data describing visual elements to be rendered on a user terminal, including layouts, textual content, and control elements for viewing reference information.

The term “emotional attribute data” refers to structured data representing an emotional state inferred from the text information, such as polarity, intensity, or categorized emotion types.

The term “emotional state” refers to an estimated condition of affect or sentiment, such as positive, negative, neutral, or more granular emotional categories, derived from analysis of the text information.

The term “response information” refers to content generated by the generative AI model in reaction to input information, including textual responses designed to correspond to the emotional attribute data.

In one embodiment, the server, the terminal, and the user cooperate to implement the invention as a concrete computer-implemented system that executes structured key-point extraction, aggregation, storage, and presentation using a generative AI model and natural language processing algorithms.

The server includes a processor, a main memory, a non-volatile storage device, a network interface, and an interface to a network-based storage service. The processor is, for example, a multi-core central processing unit or a combination of a central processing unit and a graphics processing unit. The server executes an operating system such as a general-purpose server operating system. On top of the operating system, the server executes an application framework, for example a web application framework written in an interpreter language or a compiled language such as Python, Java, or JavaScript (Node. js). The server further executes client libraries for a generative AI model service and for a natural language processing service.

The terminal is, for example, a smartphone, a tablet, or a personal computer operated by the user. The terminal includes a processor, a memory, a local storage unit, a display, an input device such as a touch panel or keyboard, and a network interface such as a wireless communication module or an Ethernet interface. The terminal executes a client application, which may be an electronic mail client, a messaging client, or a dedicated summary viewer application. The terminal communicates with the server over a network such as the Internet using a protocol such as HTTPS.

The user operates the terminal to receive communication information such as electronic mail messages or chat messages. The terminal stores the received communication information in a local message store and transmits at least a part of the content to the server. The transmitted content includes text information such as subject lines, message bodies, and metadata such as sender identifiers and timestamps.

The server stores the communication information as record information in a database residing in the storage device. The record information is held in a structured format such as a relational table, a document store, or a key-value store. For example, the server stores each message as a record including fields for a message identifier, a user identifier, text content, and message metadata. The server normalizes text encodings to a single character encoding such as UTF-8 and removes markup tags from the text using a markup parsing library. The server thereby generates normalized text information that can be processed efficiently by downstream modules.

The server analyzes the normalized text information by using a generative AI model in combination with a natural language processing algorithm. In one embodiment, the generative AI model is implemented as a transformer-based neural network. The transformer-based model includes an encoder-decoder architecture with multiple layers of self-attention, feedforward sub-layers, and residual connections. The model parameters include weight matrices for attention mechanisms and feedforward layers, and the model has been pre-trained on large-scale text corpora using an unsupervised objective such as masked language modeling or next-token prediction. During pre-training, the server or an external training system minimizes a loss function such as cross-entropy with respect to model outputs representing token probabilities. The weights are updated by using a gradient-based optimization algorithm such as stochastic gradient descent or an adaptive method, and regularization techniques such as dropout and layer normalization are applied to improve generalization.

The server fine-tunes or instructs the generative AI model for key-point extraction and sentiment estimation by supplying task-specific examples or instructions. The server encodes input text and a prompt sentence into token sequences and feeds them to the model. The server uses an inference configuration including a maximum token length, a sampling temperature, and a decoding strategy such as greedy decoding or beam search. The model outputs token sequences representing structured key points and emotional attribute data in natural language, which the server then parses.

The natural language processing algorithm utilized by the server includes tokenization, part-of-speech tagging, syntactic parsing, and named-entity recognition. These operations are implemented by statistical models or neural models such as recurrent neural networks or transformer encoders, trained on annotated corpora. The server uses these models to detect date expressions, person names, organization names, and action verbs. The server merges the results from the natural language processing algorithm with the generative AI model outputs. For example, the server compares the dates proposed by the generative AI model with the dates detected by named-entity recognition and retains only those entries that satisfy consistency rules defined by the application, thereby reducing hallucinated or erroneous entries.

The server applies rule-based post-processing that is not a mere automation of human reading. The server defines non-conventional rules that operate on internal data structures. For instance, the server maintains, in memory, a graph structure where nodes represent extracted key points and edges represent semantic similarity or temporal relationships. The server computes similarity scores by using vector representations of sentences produced by the generative AI model or by a sentence embedding model. If two nodes exceed a similarity threshold in both semantic space and date attributes, the server merges them into a single representative node, thereby performing duplicate-elimination processing that is parametrized and quantitatively controlled, rather than relying on human subjective judgment.

The server aggregates key points into reference information in a list format or in a structured data format. Internally, the server stores aggregated key points in a structured data format such as a hierarchical document (for example, a tree of key types and items). Each key point record includes fields for a type (for example “schedule,” “deadline,” “responsible actor,” “action item”), a normalized text, a confidence score, and any extracted attributes such as a normalized date. The server assigns confidence scores based on combined signals from the generative AI model, the natural language processing algorithm, and rule-based filters. The server then generates a list format representation, such as bullet-point text, by traversing this internal structure and rendering only key points whose confidence scores exceed a threshold. The server controls the behavior of the generative AI model by constructing prompt sentences that encode specific processing instructions. An example of a prompt sentence used by the server is:
“From the following email content, extract the key points as concise bullet items. Include all dates, responsible persons, locations, and deadlines. Output only bullet points and no additional explanation.

Email content:

[message text]”

In another example, the server uses a prompt sentence for generating affirmative content based on detected emotions:
“Based on the following emotional state and key points, generate a short, supportive response in polite language that acknowledges the user's feelings and encourages constructive action.

Output 2-3 sentences.

Emotional State: [emotion label]

Key points:

[bullet list of key points]”

The server encodes each prompt sentence into tokens and submits them as part of the input sequence to the generative AI model. By standardizing the prompt structure, the server ensures that outputs are emitted in a predictable format, which simplifies parsing and allows the server to maintain compact and indexed data structures representing key points.

The server stores the aggregated reference information and associated emotional attribute data as electronic files in a network storage area provided by an external storage service. The server uses an application programming interface of the external storage service to authenticate, upload, and manage files. The server serializes structured data into a format such as a structured text representation and uploads it as a file. The external storage service returns an identifier and a locator such as a uniform resource locator, and the server stores these values in the local database as identification information and reference location information. Through this association, the server can later reconstruct or fetch the summary file without scanning entire message archives, thereby reducing access latency and network bandwidth usage.

The server generates browsing screen information for presentation on the terminal. The browsing screen information includes, for example, layout instructions, title text derived from the original message subject, ordered key points, and visual indicators representing emotional attributes such as positive or negative sentiment. The server may send the browsing screen information as markup and style descriptions. The terminal renders the browsing screen information by using its graphical user interface framework. The user views a concise, machine-aggregated summary that is substantially shorter than the original communication thread.

In one embodiment, the server extracts emotional attribute data representing an emotional state from the text information by using the generative AI model. The server uses a classification head in the transformer model that outputs probabilities over a set of emotion labels. The training of this classifier uses supervised learning with a labeled dataset of text and emotion annotations. The server computes a loss such as cross-entropy between predicted label distributions and ground-truth labels and updates weights by backpropagation. During inference, the server selects one or more emotion labels whose probability exceeds a threshold and records them as emotional attribute data, stored alongside the key points in the structured data model.

The server uses emotional attribute data as additional features to refine key-point presentation and to generate affirmative response information. For example, if the emotional attribute data indicates a negative or stressed state, and the key points include a cluster of imminent deadlines, the server generates a prompt sentence emphasizing supportive and encouraging language. The generative AI model then produces a response such as: “The upcoming deadlines are challenging, but your progress so far is substantial. Prioritize the most critical tasks first, and consider delegating where possible.” The server sends this response information to the terminal, where it is displayed to the user.

The technical effects of this architecture go beyond merely automating human reading. By transforming unstructured text streams into structured, indexed records with standardized types and confidence scores, the server enables more efficient database indexing, query execution, and cache utilization. The server reduces redundant network transfers by storing compact summaries and by allowing downstream devices to request only structured key-point data rather than entire message bodies. The server improves processing speed by combining a pre-trained transformer model, which can process long sequences in parallel via self-attention, with deterministic rule-based post-processing that prunes low-confidence or duplicate entries. The system reduces computational overhead on the terminal, because heavy analysis runs on the server's optimized hardware, while the terminal performs only lightweight rendering and user interaction.

The server employs specific data structures and algorithms that produce technical advantages. For example, the server uses a batched processing approach in which multiple messages or message segments are grouped into a batch and processed together by the generative AI model and natural language processing algorithms. This reduces overhead associated with repeated model initialization and network round trips. The server further uses a caching layer to store intermediate embeddings or key-point templates, enabling reuse of previously computed representations when similar messages are processed. These techniques lower average latency and reduce the number of expensive model inference calls.

The server applies non-conventional rules that are tailored to the behavior of transformer-based models. For instance, the server compensates for known tendencies of such models to generate redundant or verbose outputs by imposing length constraints and by penalizing repetition during decoding. The server also enforces a schema by checking that each generated bullet point contains at least one actionable verb or at least one recognized entity from the named-entity recognizer. Points that do not satisfy these rules are discarded or re-generated. This combination of neural and rule-based filtering produces a level of precision and consistency that cannot be achieved through simple human-like summarization or generic text generation.

The learning procedure of the generative AI model and associated classifiers further contributes to technical improvements. During fine-tuning, the server or a coupled training system uses data augmentation techniques such as paraphrasing, synonym replacement, and temporal expression variation to increase robustness to diverse phrasing. The training pipeline may also balance classes in the emotion dataset to avoid bias toward neutral or majority sentiments. The resulting model exhibits improved generalization across domains and more stable extraction of key points, which leads to lower error rates in downstream summarization and sentiment tagging.

In another embodiment, the server uses an alternative network architecture, such as a hybrid model combining a transformer encoder with a recurrent decoder, or a model that incorporates convolutional layers for local feature extraction. The server may also employ a separate model to compute semantic sentence embeddings, and a clustering algorithm such as k-means or hierarchical agglomerative clustering to group similar key points before aggregation. These variations still operate within the same overall framework of structured key-point extraction, prompt-driven generative processing, and storage in a network-based storage area.

In a further embodiment, the terminal executes part of the analysis locally. For example, the terminal may run a lightweight natural language processing library to perform initial tokenization and language detection, thereby allowing the server to select language-specific models and resources. This reduces server-side misclassification of language and avoids unnecessary calls to inappropriate models. The terminal may also cache previously received summaries and emotional feedback so that the user can access them offline, thus reducing network load and enabling continued use under constrained connectivity conditions.

In yet another embodiment, the server presents a configuration interface allowing the user or an administrator to adjust parameters such as key-point types, confidence thresholds, and emotional label sets. The server modifies its internal rules accordingly and updates its data processing pipeline at runtime. This adaptability allows the same infrastructure to be applied to different domains, for example project management, customer support, or educational communication, without changing the underlying generative AI model architecture. The technical effect is a flexible yet consistent summarization and sentiment framework that remains efficient and predictable across use cases.

Through these embodiments, the server, the terminal, and the user cooperate in a manner that leverages generative AI models and natural language processing algorithms to improve core computer functions, including structured data management, network resource utilization, and interactive user interface responsiveness. The system does not merely replicate human reasoning but implements specific model architectures, training methods, internal data structures, and rule-based post-processing that together produce technical improvements such as increased processing speed, improved summarization accuracy, reduced error propagation, and optimized storage and retrieval of communication-derived key points.

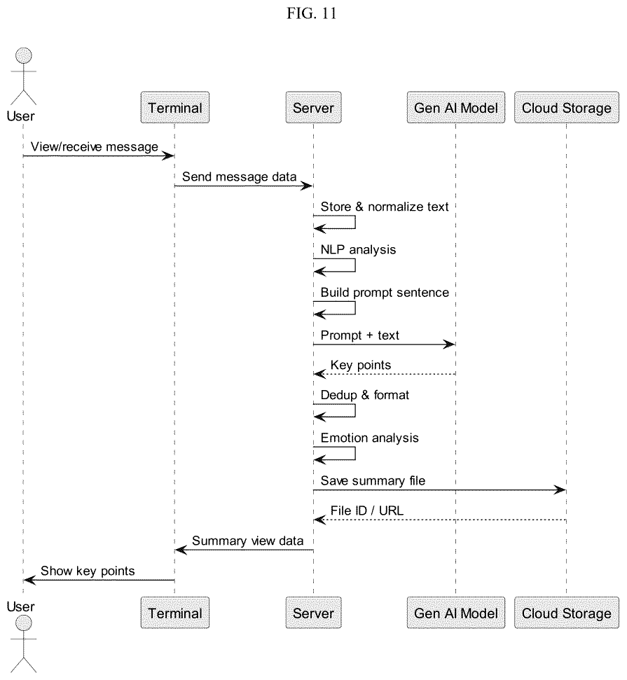

The following describes the processing flow using FIG. 11.

### Step 1

The user receives communication information on the terminal.

The terminal runs a mail or messaging application and obtains message data from an external communication service via a network protocol. As input, the terminal receives raw message data including header information (sender, recipient, timestamp, subject) and body text. The terminal writes this message data into a local message store in its storage, and displays at least the subject and a preview portion of the body text to the user. The terminal thereby converts network packets into structured local records and visual content for the user.

### Step 2

The terminal transmits communication information to the server.

The terminal detects that new message data has been stored or that the user has requested summarization. As input, the terminal takes the structured local record comprising the message identifier, subject, body text, and metadata. The terminal serializes this record into a request object, for example as a JSON structure, and sends it to the server via an HTTPS connection. The output of this step is a network request containing normalized message data delivered to the server's application endpoint.

### Step 3

The server stores record information in a storage device.

The server receives the network request at an application interface. As input, the server takes the serialized message data transmitted by the terminal. The server parses the request, validates fields such as user identifier and message identifier, and converts the data into an internal representation suitable for database insertion. The server then executes a database write operation to store the message as record information in a relational table or document collection. The output of this step is a stored record including text fields and metadata, each associated with a unique internal record identifier.

### Step 4

The server normalizes text information for analysis.

The server retrieves the text information from the stored record using the internal record identifier. As input, the server takes raw text fields that may contain markup, mixed encodings, and control characters. The server applies text-processing routines to remove markup tags, decode character encodings into a unified character set, and replace control sequences with standardized representations. The server also splits the text into sentences or segments using a sentence boundary detection algorithm. The output of this step is normalized text information, represented as a clean sequence of characters and sentence units ready for linguistic analysis.

### Step 5

The server analyzes text information with a natural language processing algorithm.

The server provides the normalized text as input to a natural language processing pipeline. As input, the server takes the sentence units and tokenizes them into word tokens. The server computes part-of-speech tags, performs syntactic parsing, and applies a named-entity recognizer to detect entities such as persons, organizations, and temporal expressions. The server uses trained models and statistical algorithms to map sequences of tokens to linguistic labels. The output of this step is a set of annotated tokens and entities, each associated with positions in the original text and semantic types such as date, actor, or action-related verb.

### Step 6

The server constructs a prompt sentence for a generative AI model.

The server receives the normalized text and the linguistic annotations from the previous steps.

As input, the server takes the raw text, extracted entities, and configuration rules describing the desired key-point types. The server assembles a prompt sentence that describes the extraction task and the required output format. The server inserts the message text and, optionally, selected entities into the body of the prompt. The output of this step is a complete prompt sentence, such as:
“From the following email content, extract the key points as concise bullet items. Include all dates, responsible persons, locations, and deadlines. Output only bullet points and no additional explanation.

Email content:

[message text]”

This prompt sentence is represented as a text string ready to be tokenized and sent to the generative AI model.

### Step 7

The server invokes the generative AI model for key-point extraction.

The server encodes the prompt sentence and, if applicable, auxiliary metadata into token sequences. As input, the server takes the prompt sentence string and model configuration parameters such as maximum token length, temperature, and decoding strategy. The server sends the encoded tokens to a generative AI model, which is a transformer-based neural network, via an inference interface. The model processes the input tokens through multiple attention and feedforward layers and outputs probability distributions over vocabulary tokens step-by-step. The server decodes these distributions to obtain an output text sequence. The output of this step is a model-generated text containing candidate key points, typically expressed as bullet items.

### Step 8

The server parses and structures the generated key points.

The server receives the generated text from the generative AI model. As input, the server takes the raw output string that may contain line breaks, bullet markers, and natural language fragments. The server applies parsing rules to split the output into individual bullet lines, removes extraneous markers, and trims whitespace. The server then converts each bullet line into a structured key-point object, assigning preliminary types (for example schedule, deadline, actor, action) using keyword patterns and the earlier entity annotations. The output of this step is a collection of structured key-point objects with textual content and tentative semantic types.

### Step 9

The server performs classification, duplicate elimination, and format adjustment on key points.

The server operates on the collection of structured key-point objects. As input, the server takes the key-point objects, their tentative types, entity annotations, and similarity metrics derived from sentence embeddings or lexical overlap. The server applies classification rules and machine-learned classifiers to refine the type of each key point, such as confirming whether a date corresponds to a meeting schedule or a submission deadline. The server computes similarity scores between key points and merges objects whose similarity exceeds a threshold and whose attributes, such as date and actor, are compatible. The server also reformats the text of each key point into a standardized template, for example “Next meeting: [date], [time], [location]” or “Responsible: [actor] for [task].” The output of this step is a deduplicated, type-confirmed, and consistently formatted set of key points.

Step 10

The server extracts emotional attribute data from the text information.

The server provides the normalized text and, optionally, the key points as input to an emotion classification module. As input, the server takes the text segments and encodes them into tokens suitable for a classification head of the generative AI model or an auxiliary classifier. The server forwards these tokens through the model to obtain scores for emotion categories such as positive, negative, neutral, or more granular labels. The server then selects one or more labels with probabilities exceeding predefined thresholds and records them as emotional attribute data associated with the original record identifier. The output of this step is a compact representation of emotional state, including labels and confidence values.

### Step 11

The server aggregates key points and emotional attribute data into reference information.

The server combines the deduplicated key points and emotional attribute data into an aggregated record. As input, the server takes the key-point set, the emotion labels, the message metadata, and the internal record identifier. The server constructs a structured representation that organizes key points into categories such as schedule, responsibilities, deadlines, and action items, and links these categories to the emotional attribute data. The server assigns an overall title derived from the original subject and attaches timestamps to the aggregated record. The output of this step is reference information in an internal structured format ready to be stored or rendered.

### Step 12

The server stores reference information as an electronic file in a network storage area.

The server serializes the reference information into a file format suitable for network storage, such as a structured text document or markup document. As input, the server takes the structured reference information and converts it into an ordered, human-readable and machine-parsable representation, including section headings and bullet lists. The server then uses an interface to an external storage service to upload the file to a network storage area. The external storage service returns an identifier and a locator for the stored file. The server records this identification information and reference location information in the local database, associated with the internal record identifier and user identifier. The output of this step is a persistent electronic file in network storage and corresponding index entries in the server's storage device.

### Step 13

The server generates browsing screen information for the terminal.

The server prepares a view specification that allows the terminal to present the reference information to the user. As input, the server takes the structured reference information, the stored file locator, and any emotional attribute data. The server constructs browsing screen information, which includes layout definitions, text segments for each key point, and, optionally, indicators such as color codes or icons representing emotional states. The server may include a link to the original electronic file in network storage. The output of this step is a response payload containing the browsing screen information, which the server transmits to the terminal over the network.

### Step 14

The terminal displays key points and emotional information to the user.

The terminal receives the browsing screen information from the server. As input, the terminal takes the view specification and associated content. The terminal parses the received data and maps it to graphical user interface components such as lists, labels, and icons. The terminal renders the key points and any emotional indicators on the display, allowing the user to quickly understand the summarized content. The output of this step is a visual presentation of the reference information on the terminal's screen.

### Step 15

The server generates affirmative response information based on emotional attribute data (optional).

The server receives a request to provide supportive content, either automatically triggered by certain emotional attribute patterns or explicitly requested by the user via the terminal. As input, the server takes the emotional attribute data and the key points associated with a record. The server constructs a prompt sentence instructing the generative AI model to generate a short, encouraging message. The server supplies the prompt sentence and context to the model, obtains the generated response text, and optionally applies a length and style filter. The output of this step is affirmative response information, which the server sends to the terminal for display to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for handling work-related communication in physical work environments, such as retail locations, warehouses, or service facilities, typically store messages or emails as unstructured text. In such systems, a processor generally archives entire message threads without extracting machine-readable key points, without normalizing the content into a structured format, and without linking the extracted information to metadata that reflects operational context. As a result, subsequent users, such as workers starting a new shift, must manually review long message histories, which consumes processing resources on user terminals, increases network traffic due to repeated retrieval of redundant data, and delays access to the specific operational instructions needed for immediate task execution.

Further, existing summarization or note-taking tools often rely on static templates or simple keyword extraction that are not dynamically adapted to the type of communication, the characteristics of the work place, or the user's role. These approaches frequently generate summaries that are either too verbose or too sparse, or that contain irrelevant content for a particular user group. This reduces the effectiveness of the user interface, leads to unnecessary client-side filtering and manual editing, and does not make full use of available computing resources in a distributed system.

Moreover, known systems that utilize machine learning or natural language processing typically do not employ a generative AI model in combination with prompt sentences that are systematically controlled and varied according to operational context. In many cases, the same generic prompt is applied to all incoming messages, producing inconsistent outputs and necessitating additional post-processing. This increases computational overhead on the server side and complicates integration with storage subsystems because the resulting data lacks a predictable structure and level of detail.

In addition, most conventional architectures do not provide an efficient mechanism for on-demand generation of higher-level summaries, such as progress reports or supervisor-oriented overviews, based on previously stored key point information. Workers or supervisors often must re-collect, re-parse, and re-summarize historical messages, causing duplication of computation, redundant network access to storage, and increased latency. This lack of a layered summarization mechanism prevents the system from efficiently reusing already processed data and imposes unnecessary load on both the communication network and processing units.

Accordingly, there is a need for an improved computer-implemented system and server-side processing method that: (i) automatically extracts key point information from work-related communication using a combination of a generative AI model and natural language processing, (ii) uses context-dependent prompt sentences to control and optimize the behavior of the generative AI model, (iii) converts and stores the resulting key point information and summary information in a structured, metadata-rich format in a cloud-type storage device, and (iv) supports on-demand generation and reuse of additional summaries, thereby improving the efficiency, scalability, and responsiveness of computer systems used for operational communication in real environments.

The specific processing by the specific processing unit 290 of the data processing device 12 in Application Example 1 is realized by the following means.

The present invention provides a server comprising a processor configured to receive communication information from a user terminal, analyze the communication information by using a generative AI model and a natural language processing algorithm to extract key point information related to work instructions or notification matters, generate a prompt sentence that instructs the generative AI model to integrate the key point information, remove duplication, and simplify expressions, and operate the generative AI model with the prompt sentence and the key point information as inputs to generate summary information for shift handover or work viewing, convert the key point information and the summary information into a structured data format associated with metadata including an identifier, time information, and user information, store the structured data format in a cloud-type storage device such that the summary information is referable to a subsequent user, dynamically change the prompt sentence according to a type of the target communication information, an attribute of a work place, or a role of a user to control an output format, a level of detail, and a style of expression of the key point information and the summary information, and acquire, based on an operation from the user terminal, selected communication information or stored key point information to generate and store, on demand, additional summary information for progress reporting or for a supervisor. This enables improvement of computer technology by reducing redundant message retrieval and manual review at user terminals, standardizing and optimizing the behavior of the generative AI model through context-dependent prompt control, lowering computational overhead through reuse of structured key point data for multiple layers of summarization, and enhancing the efficiency and responsiveness of server-side processing and cloud storage access in systems that support operational communication in real environments.

The term “communication information” refers to digital message data including text, symbols, or other machine-readable content representing work-related instructions, notifications, or discussions exchanged between users in an operational environment.

The term “user terminal” refers to an information processing apparatus operated by a user, such as a portable computing device, a stationary computing device, or another electronic device capable of sending, receiving, and displaying communication information via a network.

The term “generative AI model” refers to a machine learning model configured to generate or transform natural language text or structured data based on input data and a prompt sentence, and including, for example, large-scale neural network models capable of language understanding and generation.

The term “natural language processing algorithm” refers to a software-implemented procedure that analyzes natural language text, including operations such as tokenization, part-of-speech tagging, syntactic parsing, entity recognition, or keyword extraction, to derive structured information from unstructured text.

The term “key point information” refers to structured or semi-structured data representing distilled elements of communication information, including at least main actions, targets, constraints, or other essential elements of work instructions or notification matters.

The term “work instructions” refers to directives, tasks, or operational requirements to be executed by one or more workers in a physical or virtual work environment.

The term “notification matters” refers to informational content intended to inform users of changes, events, conditions, or other circumstances that may affect work activities or operational decisions.

The term “prompt sentence” refers to a control input, expressed as natural language or structured data, that specifies a processing objective, output format, level of detail, or style of expression and is provided to a generative AI model to guide the model's behavior.

The term “summary information” refers to natural language text or structured data generated from key point information and optionally from original communication information, and representing a condensed and organized form suitable for human comprehension or further machine processing.

The term “shift handover” refers to a transition process in which responsibility for ongoing work or tasks is transferred from one set of workers to another set of workers, typically at defined time intervals.

The term “structured data format” refers to a machine-readable representation of data, such as a record, object, or array, in which fields and their relationships are explicitly defined, thereby enabling efficient storage, indexing, retrieval, and processing by computer systems.

The term “metadata” refers to auxiliary data describing characteristics of other data, including at least identifiers, time information, user information, or context attributes associated with key point information or summary information.

The term “identifier” refers to a data value, such as a numeric value, an alphanumeric value, or another symbolic value, that uniquely or distinctively distinguishes an item of information, a user, a group, or a work context within a system.

The term “time information” refers to data indicating temporal attributes, including at least timestamps, time ranges, or scheduling information associated with communication information, key point information, or summary information.

The term “user information” refers to data identifying or describing a user or user group, including, for example, user IDs, role indicators, affiliation data, or access rights.

The term “cloud-type storage device” refers to a storage subsystem implemented over a network-accessible computing infrastructure, in which digital data objects are stored, replicated, and retrieved via standardized interfaces, such as network protocols or application programming interfaces.

The term “subsequent user” refers to a user who accesses key point information or summary information at a time later than the time at which corresponding communication information was generated or stored.

The term “work place” refers to a physical site, virtual environment, or combination thereof in which work activities are conducted, including, for example, retail spaces, warehouses, offices, or service locations.

The term “role of a user” refers to a classification or attribute indicating the function, responsibility level, or position of the user within an organization or work process, such as worker, supervisor, or manager.

The term “output format” refers to structural characteristics of data output by a generative AI model, including at least arrangement as bullet points, numbered lists, paragraphs, tables, or machine-readable records.

The term “level of detail” refers to a granularity of information contained in output data, including a degree of specificity, completeness, or abstraction in key point information or summary information.

The term “style of expression” refers to linguistic or formatting characteristics of output text, including tone, politeness level, sentence length, terminology, and use of labels or headings.

The term “work summaries” refers to summary information specifically adapted to describe work instructions, progress, or operational status in a form that is directly usable by workers or supervisors.

The term “progress reporting” refers to a process of generating information that indicates completion status, pending tasks, issues, or other progress-related aspects of work activities.

The term “supervisor” refers to a user having management or oversight responsibilities over one or more workers or processes, and typically requiring higher-level or aggregated information for decision making.

The term “additional summary information” refers to summary information generated after initial key point information or initial summary information has been stored, and representing a secondary or higher-level condensation, such as a progress report or management overview.

The term “on demand” refers to processing that is initiated responsive to a specific user request or triggering event, rather than automatically or periodically without user involvement.

In one embodiment, the server, the terminal, and the user cooperate to implement the claimed system in a networked environment including a cloud-type storage device, a communication network, and one or more physical work places such as stores, warehouses, or service facilities.

The server operates as a network-connected computing platform that includes at least one processor, a main memory, a non-volatile storage device, and a network interface. The server executes an operating system, such as a general-purpose server operating system, and middleware such as a web application framework and a storage client library. The server stores and executes a set of software modules implementing a natural language processing algorithm, a generative AI model client, a prompt sentence generator, a metadata manager, and a structured data manager.

The terminal operates as a user-operated computing device, for example a smartphone, a tablet, a notebook computer, or a workstation. The terminal includes a display, an input interface such as a touch panel or keyboard, a local processor, a memory, and a wireless or wired communication interface. The terminal executes a client application that allows the user to input, view, and select communication information, to request summaries, and to receive and display summary information provided by the server.

The user operates the terminal to create or select communication information. For example, the user composes messages or emails that describe work instructions such as “Please change the placement of today's special-sale items to the front entrance and update the price tags,” or the user selects multiple previously exchanged messages for on-demand summarization. The terminal converts the user input into digital communication information, encodes the information in a text-based format such as UTF-8, and transmits the communication information to the server over a network using a secure protocol.

The server receives the communication information as input data and stores the input temporarily in memory. The server applies a natural language processing algorithm to the received communication information prior to invoking the generative AI model. In one example, the server uses a tokenization component to segment the text into tokens, a part-of-speech tagging component to assign grammatical categories, and a dependency parsing component to determine syntactic relations between words. The server further executes a named entity recognition component to detect candidate entities such as item names, locations, dates, and quantities.

The server generates internal feature representations from the parsed text. The server converts each token and its associated tags into numerical feature vectors, for example by applying a word embedding model or a subword embedding model. The server augments the feature vectors with additional features such as entity type indicators, dependency relation labels, and position indices within the sentence. These feature vectors serve as structured inputs to downstream extraction logic and to the generative AI model.

The server extracts key point information from the communication information using a combination of rule-based logic and learned models. The server applies pattern-matching rules that reference part-of-speech tags and dependency relations, such as rules that identify action verbs connected to direct objects and prepositional phrases indicating locations or times. The server also applies a classification model that distinguishes sentences containing operational instructions from sentences containing general commentary. The server aggregates the outputs of these components to form key point information that includes, for each key point, at least an action element, an object element, and optionally a location element and a temporal element.

The server converts the extracted key point information into a structured data format, such as a record or an array of records, in which each field of the key point information is stored as a machine-readable attribute. The server associates metadata with each record, including an identifier that uniquely identifies the communication source, time information that records when the communication was generated and processed, and user information that indicates which user or user role is associated with the communication.

The server constructs a prompt sentence to control the behavior of the generative AI model.

The server generates the prompt sentence dynamically based on one or more context parameters, such as a type of the communication information (for example, daily instructions, incident reports, or inventory updates), an attribute of the work place (for example, store, warehouse, or office), and a role of the user (for example, worker, team leader, or supervisor). The server determines these parameters from metadata and/if available, from system configuration rules.

In one example, when the server generates summary information for shift handover, the server constructs a prompt sentence such as:
“Read the following extracted key points from store staff communications. Merge duplicates, remove trivial items, and rewrite them as clear, concise bullet points suitable for shift handover notes.”

In another example, when the server generates a supervisor-oriented progress report, the server constructs a prompt sentence such as:
“Based on the following key points and their completion statuses, generate a brief progress report for the store manager that highlights incomplete critical tasks and any urgent issues.”

In still another example, when the server generates on-demand summaries from a selection of messages, the server constructs a prompt sentence such as:
“From the following internal messages, extract only the operational instructions and important notices, then output them as a numbered list suitable for a shift handover note.”

The server provides the generative AI model with both the prompt sentence and the structured representation of the key point information and, in some cases, the original communication information. In one embodiment, the generative AI model is implemented as a multi-layer neural network architecture that includes an input embedding layer, multiple self-attention layers, feed-forward layers, and an output layer that generates natural language tokens. The server encodes the prompt sentence and the structured key point information into a sequence of tokens and forwards this sequence to the generative AI model through a model interface.

The server configures the generative AI model by specifying model parameters such as a maximum output length, a temperature parameter that controls diversity, and a top-k or top-p sampling parameter that restricts candidate tokens during generation. The server may adjust these parameters based on context, for example using a lower temperature for supervisor reports to produce more deterministic and formal summaries, and a higher temperature for internal working notes to allow more flexible phrasing.

The server uses a trained generative AI model that has been pre-trained on large-scale text corpora and optionally fine-tuned on domain-specific communication data. During training, the server or a training system updates the model's weight parameters by minimizing a loss function, such as a cross-entropy loss between predicted tokens and ground-truth tokens, using gradient-based optimization. The server or training system may perform data augmentation by rephrasing instructions, varying entity names, or combining multiple related messages, thereby enabling the model to generalize to diverse communication patterns.

The server applies specific rules and constraints to the generative AI model's output to ensure that the summary information conforms to a predictable structure. For example, the server may require that each bullet point begins with a verb phrase, that each instruction mentions an object, and that each summary includes at least one reference to time or location when such information is available. The server may implement these constraints by post-processing the generated tokens, by rejecting outputs that do not satisfy regular expression patterns, or by re-invoking the model with a modified prompt sentence that emphasizes the required structure.

The server stores the resulting summary information together with the key point information and the metadata in the cloud-type storage device. The server converts the data into a structured data format such as a record-based or object-based representation and uses hierarchical identifiers in object names or keys to organize data by work place, date, shift, or user role. The server sets access control policies so that only authorized terminals and users can retrieve the stored information.

The terminal accesses the cloud-type storage device indirectly through the server. When the user initiates a viewing operation, the terminal sends a request that indicates a desired time range, a work place identifier, and, optionally, the user's role. The server authenticates the request, queries the cloud-type storage device for the corresponding structured data, and returns summary information that is already adapted to the user's context according to the prompt sentence used at generation time.

The terminal presents the summary information on the display using a user interface that distinguishes key point information and summary information. For example, the terminal renders bullet-point lists of instructions, highlights critical or urgent tasks, and provides controls for the user to mark tasks as completed or to request more details. When the user selects a particular summary item, the terminal may request the associated original communication information or key point record from the server and present a detailed view.

The server utilizes the structured and metadata-rich storage format to avoid repeatedly reprocessing the same communication information. When the server generates additional summary information, such as an on-demand progress report, the server retrieves previously stored key point information instead of re-analyzing raw messages. The server then composes a new prompt sentence and invokes the generative AI model using the stored structured data as input. This layered summarization process reduces computational load because the server performs expensive natural language parsing only once per message, and reuses the derived structured representation for multiple summarization tasks.

The server further reduces network and storage overhead by performing deduplication and consolidation at the level of key point information. When multiple messages contain similar or identical instructions, the server detects similarity based on feature vectors derived from the key point representations and merges them into a single record with aggregated metadata. This reduces the number of records that must be transferred to the terminal and displayed to the user, thereby lowering communication load and improving responsiveness.

The described configuration yields several technical effects. Because the server extracts key point information using a combination of syntactic and semantic features, the system can identify operationally relevant content with higher precision and recall than simple keyword search. This reduces the number of irrelevant items that the terminal must display and the user must filter manually, thereby lowering user-side processing and improving the efficiency of the graphical user interface.

Because the server dynamically generates the prompt sentence based on context and role information, the generative AI model produces summaries whose length, structure, and level of detail are appropriate for the requesting user group. This context-aware control of the model's behavior reduces the need for downstream trimming or reformulation and enables the server to output structured text that is directly consumable by the terminal. As a result, the system reduces total processing time and minimizes redundant text transformations.

Because the server stores key point information and summary information in a structured, metadata-rich format in the cloud-type storage device, the server can perform efficient indexed retrieval and selective transmission of only relevant data segments to the terminal. This structured storage strategy improves cache utilization, lowers latency, and reduces the volume of data transmitted over the network, thereby enhancing communication efficiency and enabling scalable operation across many users and work places.

The system departs from mere automation of human reading and summarization by employing non-conventional internal data flows and rule sets tailored to computer execution. The server uses machine-readable feature vectors, explicit metadata fields, and structured records that have no direct counterpart in human cognitive processes. The server applies algorithmic constraints, pattern-based post-processing, and dynamic prompt control that collectively result in improved processing speed, improved accuracy of instruction extraction, reduced error rates in summary content, and reduced computational redundancy.

In alternative embodiments, the server may use different neural network architectures for the generative AI model, such as encoder-decoder networks, recurrent neural networks, or convolutional sequence models, while still employing context-dependent prompt sentences and structured key point representations. The server may also incorporate additional modules, such as topic classifiers, anomaly detectors, or priority scorers, that operate on the same structured key point information to further refine which instructions are highlighted to the user.

In another embodiment, the terminal may perform a subset of natural language processing operations locally, such as initial tokenization or language detection, before sending compact representations to the server. This reduces uplink bandwidth requirements and allows the server to focus its computational resources on higher-level extraction and generative processing. The server may adapt its processing pipeline based on whether the terminal has provided pre-processed data or raw text.

In still another embodiment, the server may adjust model parameters or select among multiple generative AI models based on measured system load, available computational resources, or service-level requirements. For example, the server may select a smaller, faster generative AI model for real-time shift handover at peak hours and a larger, more accurate model for offline generation of end-of-day reports. This selection mechanism further improves system responsiveness and resource utilization.

Across these embodiments, the server, the terminal, and the user cooperate in a way that allows the system to transform unstructured communication information into structured, context-aware, and reusable summary information. The technical configuration of feature extraction, context-dependent prompt sentence generation, generative AI-based summarization, and structured storage in a cloud-type storage device provides specific improvements in data management, computational efficiency, and communication performance, thereby enabling practical and scalable deployment in real operational environments.

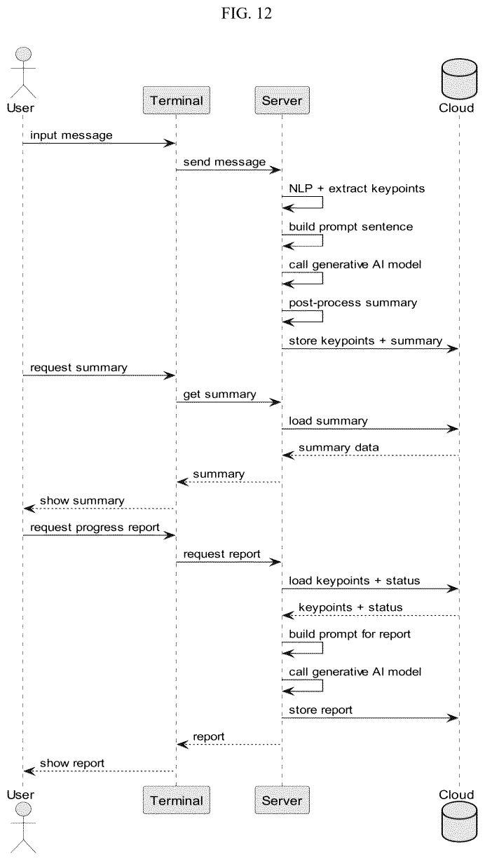

The following describes the processing flow using FIG. 12.

### Step 1

The user operates the terminal to create or select communication information. The input is user-generated content, such as text messages or emails describing work instructions or notifications. The terminal converts the user input into a digital text string encoded in a character encoding format and stores the text in local memory. The terminal may also attach local metadata, such as a terminal identifier and a local timestamp. As a result, the output is structured communication information ready for transmission to the server.

### Step 2

The terminal transmits the communication information to the server. The input is the encoded text string and associated metadata stored at the terminal. The terminal encapsulates this data in a network request, adds authentication tokens, and sends the request to the server via a network protocol. The terminal thereby performs data packaging and secure transmission operations. The output is a network message containing the communication information delivered to the server.

### Step 3

The server receives and buffers the communication information. The input is the network message transmitted by the terminal. The server decodes the message, verifies authentication data, and stores the text content and metadata in working memory. The server may also write a temporary record to a transactional storage component for reliability. The output is a normalized internal representation of the communication information stored in server

### memory for further processing. Step 4

The server applies a natural language processing algorithm to the communication information. The input is the normalized text string. The server performs tokenization to split the text into tokens, applies part-of-speech tagging to assign grammatical categories, and executes dependency parsing to determine syntactic relations. The server further runs a named entity recognition routine to detect entities such as item names, locations, dates, and quantities. The output is a linguistically annotated representation of the text, including tokens, tags, dependency links, and recognized entities.

### Step 5

The server generates feature vectors and candidate key point segments. The input is the annotated text from Step 4. The server converts tokens and tags into numerical vectors using embedding tables and encodes additional attributes such as entity types and sentence positions. The server then segments the text into candidate instruction units, for example by splitting at sentence boundaries and clause markers. The output is a set of candidate segments, each associated with a structured feature vector representation.

### Step 6

The server extracts key point information from the candidate segments. The input is the set of feature-enriched segments from Step 5. The server applies rule-based filters that search for patterns such as action verbs linked to direct objects and prepositional phrases indicating location or time. The server may also apply a classification model to identify segments that contain operational instructions or important notifications. The server aggregates the selected segments into key point records, each including fields such as action, object, location, and time. The output is a collection of key point information records derived from the original communication information.

### Step 7

The server associates metadata and converts key point information into a structured data format. The input is the collection of key point records from Step 6 and the original metadata received from the terminal. The server attaches identifiers, time information, and user information to each key point record and converts the records into a structured data format such as an array of objects or records. The server may also generate indices or keys based on work place, date, and user role. The output is structured key point information with associated metadata, ready for storage or further processing.

### Step 8

The server constructs a context-dependent prompt sentence for a generative AI model. The input is the structured key point information and context parameters such as communication type, work place attribute, and user role. The server consults configuration rules or templates to select and fill prompt patterns. For example, the server may generate a prompt sentence such as: “Read the following extracted key points from store staff communications. Merge duplicates, remove trivial items, and rewrite them as clear, concise bullet points suitable for shift handover notes.” The output is a prompt sentence that explicitly instructs the generative AI model regarding integration, filtering, and formatting behavior.

### Step 9

The server invokes the generative AI model using the prompt sentence and the key point information. The input is the prompt sentence from Step 8 and the structured key point data from Step 7. The server encodes the prompt sentence and the key point fields into token sequences and forwards the sequences to a neural network model implementing the generative AI functionality. The model internally applies attention-based computations over the token vectors to generate a sequence of output tokens representing a summary. The output is raw summary text produced by the generative AI model, typically in the form of bullet points or numbered items.

### Step 10

The server post-processes the raw summary text to obtain standardized summary information. The input is the raw output tokens or text generated in Step 9. The server splits the text into individual lines or bullets, trims whitespace, and applies formatting rules, such as ensuring that each line begins with an action phrase and that duplicated or empty items are removed. The server may re-apply simple pattern checks to confirm that action, object, and, where applicable, time or location are represented. The output is cleaned and standardized summary information suitable for direct presentation to the user.

### Step 11

The server stores the key point information and the summary information in a cloud-type storage device. The input is the structured key point records from Step 7 and the standardized summary information from Step 10. The server encapsulates these data elements into structured storage objects, associates object identifiers and paths based on work place, date, and shift, and sends write requests to the cloud-type storage device using a storage client library. The output is a set of persisted objects that can be retrieved later by identifiers or by indexed queries.

### Step 12

The terminal requests summary information for viewing. The input is a user operation at the terminal, such as opening a shift overview screen or selecting a time range. The terminal constructs a query including parameters such as work place identifier, time window, and user role, appends authentication data, and sends the query to the server via a network request. The output is a server-directed retrieval request specifying which summary information the user wishes to view.

### Step 13

The server retrieves and filters summary information from the cloud-type storage device. The input is the retrieval request from Step 12. The server authenticates the request, determines relevant storage object identifiers from the metadata, and reads the corresponding objects from the cloud-type storage device. The server may filter or sort the retrieved data based on time, priority, or user role, so that only necessary summary entries are prepared for transmission. The output is a response payload containing selected summary information and, optionally, related key point information.

### Step 14

The terminal receives and renders the summary information for the user. The input is the response payload from Step 13. The terminal parses the structured data, generates visual elements such as bullet lists or categorized sections, and draws them on the display. The terminal may also associate touch actions or controls with each summary item, enabling the user to request details or mark items as completed. The output is a graphical presentation of the summary information that the user can read and interact with.

### Step 15

The user interacts with the displayed summary items to update status or request additional summaries. The input is the rendered summary interface on the terminal display. The user selects items, marks them as completed, or chooses a set of items for on-demand summarization. The terminal records these operations as event data, attaches relevant identifiers for the summary items, and sends the event data back to the server. The output is a set of status updates or on-demand summarization requests delivered to the server.

### Step 16

The server generates additional summary information based on stored key points and user actions. The input is the status update or on-demand summary request from Step 15 and the previously stored key point information in the cloud-type storage device. The server retrieves the relevant key points and current completion statuses, constructs a new prompt sentence such as: “Based on the following key points and their completion statuses, generate a brief progress report for the store manager,” and invokes the generative AI model again using the prompt and structured data. The server post-processes the new model output in the same manner as in Step 10. The output is additional summary information, such as a progress report for a supervisor, which can be stored and later retrieved in the same storage and retrieval pipeline.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In multi-party digital communication environments, such as group messaging, conferencing, and collaboration platforms, a large volume of unstructured text is generated continuously. Conventional systems typically store this communication data as sequential message logs. In such systems, when a user joins an ongoing conversation at a later time, the user is required to manually scroll through and read a substantial amount of historical messages to understand the current context, including what decisions have been made, what tasks are pending, who is responsible for each task, and what deadlines apply. This manual review is time-consuming, cognitively burdensome, and error-prone.

Existing approaches that simply apply generic text summarization or keyword extraction on static documents are not well suited to dynamic, streaming conversations. These approaches often fail to preserve essential conversational structure, such as progress state, explicit and implicit decisions, task assignments, and temporal constraints, and they generally do not provide such information in a machine-readable, structured format that can be efficiently stored, indexed, and retrieved. As a result, known systems do not sufficiently improve the functioning of the underlying computer system: database resources are consumed by raw message logs that are not optimized for contextual retrieval, and server and network resources are repeatedly used for transmitting and rendering long histories to late-joining users.

Furthermore, conventional architectures typically treat generative AI models as standalone text processors, without tightly integrating prompt design, structured output constraints, and storage orchestration into the core system logic. Without systematic control of prompt sentences, model input, and expected structured output formats, previous systems cannot reliably obtain normalized, structured key-point data suitable for efficient storage in remote data storage devices and for low-latency retrieval. This leads to inconsistent data representations, additional post-processing overhead on the server, and inefficient use of storage and network resources.

Accordingly, there is a need for a computer-implemented system that improves the operation of server-side processing and remote storage management by (i) automatically aggregating conversation units from raw message streams under predetermined temporal or volumetric conditions, (ii) generating prompt sentences that constrain a generative AI model to output key-point information in a predefined structured data format, (iii) storing such structured key-point information in a remote storage device in association with underlying message records, and (iv) enabling late-joining user terminals to obtain concise, structured summaries instead of full logs. Such a system should reduce computational and bandwidth demands, improve data organization and retrieval efficiency, and enhance the practical usability of multi-user communication systems from a computer technology standpoint.

The specific processing by the specific processing unit 290 of the data processing device 12 in Example 2 is realized by the following means.

The present invention provides a server comprising a processor configured to acquire communication information transmitted from user terminals and record the communication information as structured data including identification information and time information in a storage device, to automatically extract, from the storage device, communication information sets corresponding to conversation units based on predetermined time conditions or record-number conditions, to analyze each communication information set by using a generative AI model as a natural language processing technique so as to extract key-point information including at least conversation progress, decision items, task items, responsible entities, and deadlines, to generate and apply a prompt sentence that instructs the generative AI model to output the key-point information in a predefined structured data format, to convert the extracted key-point information into structured key-point information based on an output of the generative AI model, to store the structured key-point information in a remote storage device in a format referable by later-participating users while maintaining, in association in the storage device, reference information indicating the structured key-point information stored in the remote storage device, and to respond to a request from a user terminal by acquiring the structured key-point information from the remote storage device and converting the structured key-point information into display data transmittable to the user terminal. This enables an improvement in the functioning of the computer system by transforming unstructured, streaming communication data into normalized, structured key-point data optimized for storage and retrieval, reducing processing and bandwidth required for late-joining users to understand conversation context, and providing a deterministic, prompt-controlled interface to the generative AI model that yields consistent, machine-readable summaries tightly integrated with server-side data management.

The term “processor” refers to a hardware execution unit, such as a central processing unit or a processing circuitry, that executes machine-readable instructions to perform data acquisition, analysis, transformation, and storage control operations.

The term “user terminal” refers to an information processing apparatus, such as a communication device or a computing device, operated by a user to transmit communication information to a server and to receive and display data from the server.

The term “communication information” refers to digital data representing exchanges among users, including at least message content, sender information, and temporal information, which are generated and transmitted in a multi-user communication environment.

The term “structured data” refers to data organized according to a predefined schema, such as records including identification information, time information, and message content fields, enabling systematic storage, indexing, and retrieval by a computer system.

The term “identification information” refers to data indicating at least one of a user identifier, a conversation identifier, a channel identifier, or a message identifier, which allows the computer system to distinguish among different entities or records.

The term “time information” refers to data indicating temporal attributes of communication information, including at least timestamps representing when messages were transmitted or received.

The term “storage device” refers to a data storage arrangement, such as a memory or a local database system, that stores structured data including communication information and associated reference information.

The term “remote storage device” refers to a data storage arrangement accessible via a communication network, such as a network-based storage system or a cloud storage system, that stores structured key-point information for later retrieval.

The term “communication information set” refers to a group of communication information elements selected from the storage device according to at least one criterion, such as a time-based condition or a record-number-based condition, and corresponding to a unit of a conversation.

The term “conversation unit” refers to a logical segment of communication information that represents a single conversation session or a bounded portion of a conversation, defined based on temporal or volumetric criteria.

The term “predetermined time condition” refers to a rule specifying a time-related threshold, such as a time interval or a duration, used by the processor to select communication information into a conversation unit.

The term “predetermined record-number condition” refers to a rule specifying a threshold number of communication records, used by the processor to determine when to group communication information into a conversation unit.

The term “generative AI model” refers to a machine-learned model, such as a neural network-based language model, configured to generate or transform natural language text or structured representations in response to input data and instructions.

The term “natural language processing technique” refers to computational processing methods that enable a computer system to analyze, interpret, or generate human language, including at least text analysis, summarization, and information extraction.

The term “key-point information” refers to information extracted from communication information that summarizes essential aspects of a conversation, including at least conversation progress, decision items, task items, responsible entities, and deadlines.

The term “conversation progress” refers to information indicative of a current state or advancement of a discussed subject within a conversation, such as a completion status or percentage of progress.

The term “decision items” refers to information indicating determinations or resolutions reached during a conversation, such as agreed actions, approvals, or selected options.

The term “task items” refers to information indicating actions to be performed as outcomes of a conversation, such as work items, follow-up activities, or assigned operations.

The term “responsible entities” refers to information indicating persons, roles, or organizational units that are designated to perform or oversee specific task items or decisions.

The term “deadlines” refers to information indicating time limits or due dates by which specific tasks or actions are expected to be completed.

The term “prompt sentence” refers to a text instruction or a set of text instructions provided as input to the generative AI model to specify how the model should process communication information and in what format it should output key-point information.

The term “structured key-point information” refers to key-point information organized according to a predefined structured data format, such as a schema with fields for conversation progress, decision items, task items, responsible entities, and deadlines.

The term “structured data format” refers to a predefined arrangement of data fields and data types, such as a record or object with named attributes, which enables consistent machine-readable representation of key-point information.

The term “reference information” refers to data stored in association with communication information in the storage device that indicates a location, identifier, or access path of corresponding structured key-point information stored in the remote storage device.

The term “display data” refers to data derived from structured key-point information and formatted in a manner suitable for presentation on a user terminal, such as text, labels, and layout information interpretable by a user interface.

The term “later-participating user” refers to a user who accesses a conversation after at least a part of the communication information of the conversation has already been exchanged and stored.

The term “analyze” refers to performing computational operations on communication information by the processor, including at least parsing, interpreting, and extracting key-point information using a generative AI model or a natural language processing technique.

The term “convert” refers to transforming data from one representation to another by the processor, including at least transforming unstructured text into structured key-point information or transforming structured key-point information into display data.

The term “store” refers to writing data to a storage device or remote storage device in a durable form such that the data can be subsequently retrieved and used by the computer system.

The term “acquire” refers to obtaining data from a source by the processor, including at least receiving communication information from a user terminal or reading records from a storage device or a remote storage device.

The term “control” refers to managing operations of the generative AI model or storage devices by the processor, including at least determining input parameters, enforcing output formats, and orchestrating read and write operations.

In one embodiment, a server includes a processor, a main memory, a non-volatile storage device, a network interface, and an interface to a remote storage device. The server executes an operating system and server-side application software that implement functions for acquiring, analyzing, transforming, and storing communication information and associated structured key-point information. The server cooperates with one or more terminals operated by users via a communication network.

A terminal includes a processor, a memory, an input interface such as a keyboard or touch panel, an optional audio input interface such as a microphone, a display device such as a liquid crystal display or organic light-emitting diode display, and a network interface such as a wireless communication module. The terminal executes communication software such as a messaging application that enables the user to input messages and to view messages and summaries supplied from the server.

A user operates the terminal to start a communication application and to generate communication information. The terminal encodes each user message as structured data including at least message content, a sender identifier, a conversation identifier, and a timestamp. The terminal transmits the structured data to the server over a network using a communication protocol such as Hypertext Transfer Protocol Secure. The terminal may additionally transmit authentication information and device identifiers to allow the server to perform access control and logging.

The server receives the structured communication information via the network interface and stores the information in a storage device such as a database system. The server maps each received message to a data structure including fields for conversation identifier, sender identifier, timestamp, content, and additional attributes such as language code or message type. By using structured data with well-defined fields, the server enables efficient indexing and querying, which reduces access time and resource consumption when aggregating and analyzing communication information.

The server organizes the communication information into communication information sets corresponding to conversation units. The server applies time-based and record-count-based rules to determine boundaries for conversation units. For example, the server may treat messages that occur within a certain time interval and belong to the same conversation identifier as one conversation unit, and may split the unit when an idle time exceeds a threshold or when a number of messages exceeds a specified count. The server uses these deterministic rules to create conversation units of manageable size so that the subsequent analysis with a generative AI model can be executed within computational and token limits, while maintaining coherence of the conversation context. This structured segmentation of streaming messages is not merely a human-like partition but is optimized for machine processing constraints, thus improving processing efficiency.

The server analyzes each conversation unit by using a generative AI model. In one embodiment, the generative AI model is a large-scale neural network-based language model implemented as a transformer architecture including multiple self-attention layers, feed-forward layers, layer normalization components, and learned embedding vectors. The generative AI model is trained on a large corpus of text data by minimizing a loss function such as cross-entropy between predicted tokens and ground truth tokens, using optimization methods such as stochastic gradient descent or variants thereof. During training, the model updates weight parameters in the attention layers and feed-forward layers in response to gradients computed from the loss function. The server or an external training system can further fine-tune the generative AI model on domain-specific conversation data, including annotated examples of conversation progress, decision items, task items, responsible entities, and deadlines, thereby improving the accuracy of key-point extraction in the specific communication environment.

The server provides the generative AI model with input sequences constructed from conversation units and prompt sentences. The server reuses the following example of a prompt sentence:
“Analyze the following multi-user conversation. Your task is to extract the key points so that a new participant can quickly understand the current situation. Summarize the conversation and return a JSON-like structure with the following fields: status, decisions, next_steps, owners, and deadlines. Use short, clear English phrases. Conversation: [conversation text here].”

The server optionally uses other prompt sentences that constrain the model to produce lists of specific categories such as “conversation progress,” “decision items,” “task items,”
“responsible entities,” and “deadlines.” The server treats the prompt sentence as a control instruction that defines the output schema and the extraction criteria, thereby converting an otherwise generic language model into a specialized extractor for machine-readable key-point information. The server can maintain a library of prompt templates and select or compose an appropriate template according to conversation type, language, or domain.

The server does not rely on the generative AI model as a black box. The server pre-processes the conversation text before providing it to the generative AI model. The server removes non-informative markers, normalizes user identifiers into abstract role labels, detects and merges repeated or near-duplicate messages, and splits extremely long messages into segments while preserving context references. The server also applies tokenization compatible with the generative AI model, and truncates or window-slices the conversation to meet a token length constraint. These operations reduce unnecessary tokens, minimize memory footprint, and improve the throughput of model inference while maintaining essential semantic content.

The server receives an output sequence from the generative AI model. In one embodiment, the server instructs the generative AI model to generate outputs that resemble a structured list with explicit labels, such as “status: . . . ”, “decisions: . . . ”, “next_steps: . . . ”, “owners: . . . ”, and “deadlines: . . . ”. The server parses the output text according to these labels using deterministic parsing rules. For example, the server identifies substrings after label markers, splits them into list elements based on punctuation and conjunctions, and assigns each element to a corresponding field in a key-point data structure. This post-processing is not merely a generic text interpretation; it exploits the specific structure enforced by the prompt sentence and yields a normalized, machine-parsable representation of the conversation key points.

The server converts the parsed results into structured key-point information using a predefined schema. The schema includes fields for conversation identifier, status information, decision item list, task item list, responsible entity list, deadline list, and metadata such as generation time, model version, and language. The server stores the structured key-point information in a remote storage device such as a network-based storage system. The server assigns a storage path that depends on the conversation identifier and on the time of generation. The server creates and stores reference information in the local storage device, linking each conversation unit record to its corresponding structured key-point information in the remote storage device. This two-level storage strategy, with raw conversation data locally indexed and summaries remotely stored in a structured, referenceable format, improves retrieval performance and reduces redundancy by avoiding repeated summarization for the same conversation unit.

The server responds to requests from terminals operated by users who join a conversation later. When a user navigates to a conversation summary function on the terminal, the terminal sends a request specifying a conversation identifier or other selection parameter. The server retrieves the associated reference information from the storage device, accesses the structured key-point information from the remote storage device, and transforms the structured data into display data that can be rendered by the terminal. The server maps internal identifiers to user-friendly labels, reorders items according to importance scores obtained during analysis, and shortens or merges redundant items. By transmitting compact and structured display data instead of full message logs, the server reduces network bandwidth usage, decreases latency until the summary appears on the terminal, and reduces rendering overhead on the terminal.

The terminal receives the display data and presents it on the display device in a form that allows rapid comprehension. The terminal may highlight deadlines using color attributes, group tasks by responsible entity, and allow the user to expand or collapse sublists of decisions and tasks. The terminal can also provide user interface functions for filtering or searching within the structured key-point information without requiring additional requests to the server, thereby offloading some interaction logic to the terminal side and further reducing network traffic.

The server in some embodiments employs alternative generative AI models or hybrid pipelines. For example, the server may use a generative AI model as a first-stage extractor to identify candidate sentences containing decisions and tasks, and then apply a rule-based or classifier-based second-stage processor that refines these candidates into normalized key-point entries. The server may compute numerical confidence scores for each extracted key point based on model probabilities, internal consistency checks, or duplication counts. The server may discard or flag low-confidence items, thereby improving the reliability of the stored summaries.

The server in other embodiments dynamically adjusts parameters of the generative AI model, such as temperature or maximum output length, depending on conversation type or length. The server may instruct the generative AI model with prompt sentences that explicitly specify maximum numbers of key points per category or that require explicit omission of irrelevant details. Such non-conventional use of prompt engineering and dynamic parameter control, tied to storage and indexing constraints, improves the determinism and reproducibility of the output, which is important for technical integration with databases and remote storage systems.

The server manages internal data structures designed for efficient summarization and retrieval. For example, the server may maintain an inverted index that maps conversation identifiers and time ranges to summary records, and may maintain a summary cache in volatile memory for recently accessed conversations. The server may store precomputed hash values or checksums of conversation units to detect whether a unit has changed since last summarization. When the server detects that new messages have not materially changed key-point content, the server can avoid re-running the generative AI model and can instead reuse existing structured key-point information, thereby reducing computational load and response time.

The server improves computer technology through multiple effects. Because the server transforms long and potentially redundant message logs into compact, structured key-point information, the amount of data that must be transferred and rendered for late-joining users is reduced. This directly lessens network traffic and server-to-terminal bandwidth usage. Because the server uses specific prompt sentences and deterministic parsing rules to obtain normalized structured representations from the generative AI model, the server avoids expensive ad hoc parsing and manual correction that would otherwise be necessary. Because the server segments conversations into units based on technical constraints such as token limits and database retrieval efficiency, the generative AI model's computational workload is balanced, leading to faster and more predictable inference times. All of these features contribute to improved processing speed, reduced memory footprint, and improved reliability of the overall communication system.

The server also uses training strategies for the generative AI model and related components to optimize performance. A training system may construct training examples where raw conversation units are paired with target key-point structures. The training system may compute a loss function that penalizes missing or incorrectly categorized key points, as well as a structural loss that penalizes deviation from the expected output schema. The generative AI model may be fine-tuned on these examples, with backpropagation updating attention weights, embedding vectors, and output layer parameters. This level of explicit structural supervision results in a model that is better aligned with the server's structured summary schema, thereby reducing parsing errors and post-processing workload.

The server, in other embodiments, uses additional feature extraction techniques on top of the generative AI model output. For example, the server may compute numerical representations of sentences using embedding techniques and cluster similar candidate tasks or decisions to merge duplicates. The server may use unsupervised or semi-supervised methods to detect patterns in deadlines or responsible entities. These additional transformations optimize the structured key-point information for storage and retrieval by compressing repetitive information and improving indexing structures.

The user benefits from these improvements without requiring any manual summarization operations. The user simply continues to use the terminal for standard communication, while the server continuously or periodically analyzes, summarizes, and stores key-point information. When the user joins a conversation later, the terminal can show a concise, structured summary in near real-time, instead of forcing the user to scroll through large volumes of historical messages. The technical configurations of server, terminal, storage device, remote storage device, and generative AI model cooperate to yield an integrated system that is not merely an automation of human summarization but rather an improvement in data management, processing efficiency, and communication system performance at the computer technology level.

In further embodiments, the server may be implemented on a distributed computing infrastructure where different nodes handle message ingestion, generative AI model inference, and remote storage management. The server may use message queues between modules to decouple ingestion from analysis, and may apply load balancing to distribute inference processing across multiple instances of the generative AI model. The server may also support alternative storage technologies for structured key-point information, such as document stores or key-value stores, and may adapt the schema accordingly. Despite such variations, the underlying concept of generating, via controlled prompt sentences, structured key-point information optimized for computer storage and retrieval, remains common across the embodiments.

Through these configurations, the server, the terminal, and the user interact in a manner that yields improved utilization of computational resources, enhanced accuracy and consistency of conversation summaries, and reduced latency and bandwidth in providing context to late-joining users, thereby implementing the claimed invention in a concrete and technically advantageous way.

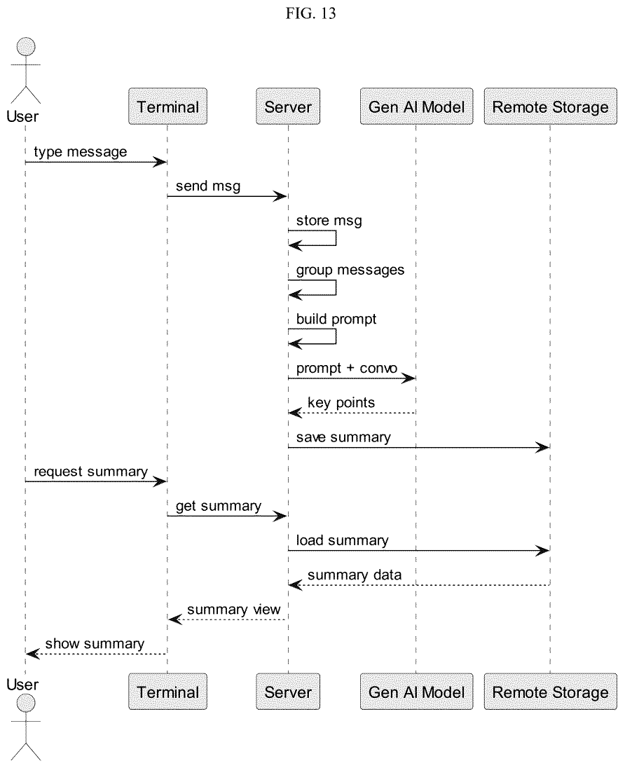

The following describes the processing flow using FIG. 13.

### Step 1

The user operates the terminal to start a communication application and input a message.

The input is user-generated text (and optionally voice) content. The terminal converts the input into structured message data by adding fields such as a user identifier, a conversation identifier, a timestamp, and a device identifier. The terminal performs data formatting, for example encapsulating the text and metadata into a JSON object, and then transmits the structured message data to the server via a secure network protocol.

### Step 2

The server receives the structured message data from the terminal through a network interface.

The input is the JSON message object sent by the terminal. The server parses the JSON, validates authentication tokens and data formats, and converts the message into an internal data structure with fields such as conversation ID, sender ID, message text, and timestamp. The server then writes this internal data structure into a storage device such as a database, performing a database insert operation and updating indices so that messages can be efficiently retrieved by conversation ID and time order. The output is a stored record of the message with associated indices.

### Step 3

The server groups stored messages into a communication information set corresponding to a conversation unit.

The input is a collection of message records retrieved from the storage device for a specific conversation ID, together with their timestamps and sequence information. The server applies data processing to split or merge records based on predetermined time conditions (such as message gaps exceeding a threshold) and predetermined record-number conditions (such as a maximum number of messages per unit). The server sorts messages by timestamp, segments them into coherent conversation units, and outputs a structured communication information set that includes an ordered list of messages and metadata indicating the unit boundaries.

### Step 4

The server constructs a text representation of the conversation unit to be used as input to the generative AI model.

The input is the communication information set produced in the previous step. The server concatenates the message texts in chronological order and may prepend speaker labels, such as “User A:” or role-based labels, to each line. The server removes non-informative system messages, normalizes whitespace, and truncates or window-slices excessively long conversations according to a token-length constraint. The output is a cleaned and normalized conversation text string suitable for tokenization and processing by the generative AI model.

### Step 5

The server generates a prompt sentence to control the behavior and output format of the generative AI model.

The input is the cleaned conversation text and configuration data indicating the desired output schema (for example, status, decisions, next steps, owners, and deadlines). The server executes application logic that combines a fixed instruction template with the conversation text. For example, the server generates:
“Analyze the following multi-user conversation. Your task is to extract the key points so that a new participant can quickly understand the current situation. Summarize the conversation and return a JSON-like structure with the following fields: status, decisions, next_steps, owners, and deadlines. Use short, clear English phrases. Conversation: [conversation text here].”

The server replaces “[conversation text here]” with the actual conversation text. The output is a full prompt sentence string that encodes both instructions and content.

### Step 6

The server sends the prompt sentence and conversation text to the generative AI model and obtains a model output.

The input is the prompt sentence generated in Step 5. The server tokenizes the prompt according to the generative AI model's tokenizer, constructs an inference request that includes model name, tokenized input, and configuration parameters (such as maximum token count and temperature), and transmits this request to the generative AI model via an API. The generative AI model executes a sequence of matrix multiplications and nonlinear transformations in its neural network layers to compute probability distributions over possible output tokens, and then generates an output text sequence. The server receives the output text, checks for errors, and logs model usage metadata. The output is a raw model response text containing summarized and structured key-point content.

### Step 7

The server parses the model output and converts it into structured key-point information according to a predefined schema.

The input is the raw model response text obtained from the generative AI model. The server analyzes the text to identify label markers such as “status:”, “decisions:”, “next_steps:”, “owners:”, and “deadlines:”. The server extracts substrings following each label, splits them into lists based on punctuation and conjunction patterns, and trims whitespace. The server performs data normalization, such as standardizing date expressions into a fixed format and mapping names to standardized identifiers where possible. The output is a structured key-point data object containing fields for conversation ID, status, decision items, task items, responsible entities, deadlines, and metadata.

### Step 8

The server stores the structured key-point information in a remote storage device and maintains reference information in the local storage device.

The input is the structured key-point data object. The server serializes this object into a standardized storage format, such as a JSON document, and generates a storage path that encodes conversation ID and time. The server uses a remote storage interface to upload the document to a remote storage device, such as a network-based storage system. The server also updates the local storage device with reference information, including the remote storage path and a link to the underlying conversation unit. This data processing step creates a two-level reference structure, and the output is a stored summary file in the remote storage and an updated reference record in the local storage.

### Step 9

The user operates the terminal to request a summary of a specific conversation.

The input is the user's selection operation, such as tapping a “View Summary” control in the communication application. The terminal interprets this operation and generates a request message that includes at least the conversation identifier and user authentication data. The terminal formats the request as a network message, for example as an HTTP request, and sends it to the server. The output is a transmitted summary request that can be processed by the server.

### Step 10

The server retrieves the structured key-point information based on the user's request and prepares display-ready data.

The input is the summary request containing the conversation identifier and user credentials.

The server authenticates the user, queries the local storage device for reference information associated with the specified conversation, and reads the corresponding structured key-point file from the remote storage device. The server deserializes the stored document into an internal object and may reorder or filter items based on relevance or recency. The server then transforms the internal object into display data, such as a compact structure with text labels and grouped lists, optimized for rendering on the terminal display. The output is a response message containing the display data.

### Step 11

The terminal receives the display data from the server and presents the key-point information to the user.

The input is the response message that includes the structured display data. The terminal parses the response, maps fields such as status, decisions, next steps, owners, and deadlines to user interface components, and renders these components on the display device. The terminal may apply visual formatting, such as bullet lists or highlighting for urgent deadlines. The terminal thus outputs a visual summary on the screen, enabling the user to quickly understand the conversation context without downloading or processing the entire raw message history.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In many computing environments, large volumes of unstructured communication data such as spoken conversations, online meetings, text chats, and electronic messages are accumulated on networked computers. Conventional systems typically store such data as raw logs or simple transcripts without transforming them into machine-readable structures that can be efficiently searched, summarized, or correlated with user states. As a result, computer resources are consumed by repeatedly scanning and heuristically filtering lengthy text or audio logs, which leads to high processing latency, poor scalability, and limited usefulness for users who need to quickly grasp key decisions or tasks. Existing summarization and sentiment-analysis tools are often implemented as stand-alone services that operate on static documents. These tools generally do not maintain consistent associations between extracted key points, temporal information, speaker information, and emotional context over the lifespan of a conversation. Consequently, computers are unable to offer low-latency, context-aware retrieval of “what was important, who said it, and in what emotional state,” and cannot systematically maintain this information in a structured, indexable representation optimized for later machine processing.

Furthermore, although generative AI models can produce summaries or responses from input text, naïve integration of such models into server systems can lead to unstable outputs, duplicated processing, and opaque data flows. In conventional architectures, generative AI models are frequently invoked in an ad-hoc manner without explicit prompt management, without structured metadata generation, and without persistent linkage between model outputs and underlying session context. This limits the computer's ability to reuse generated results, to perform efficient incremental updates, and to enforce consistent behavior across different sessions and user terminals.

Additionally, conventional systems that attempt to react to user emotions usually rely on simple sentiment scores applied at the user interface layer, rather than integrating emotion analysis with the communication summary pipeline. As a consequence, the computer cannot automatically combine conversation key points with emotional signals to trigger targeted, machine-generated supportive or corrective outputs. This leads to underutilization of available computation and communication resources and prevents the computer from dynamically adapting information presentation or automated responses based on users'emotional states.

Accordingly, there is a need for an improved computer-implemented system that: (i) systematically transforms multi-modal communication streams into structured key point and summary metadata associated with temporal and speaker information; (ii) invokes generative AI models through explicit, context-rich prompt sentences under programmatic control; (iii) integrates emotion extraction into the same metadata pipeline; and (iv) stores these combined results in a form that is efficiently retrievable and usable by user terminals. Such a system should improve the way computers internally represent, index, and serve communication-related information, thereby enhancing processing efficiency, response time, and robustness of downstream applications that depend on these data.

The specific processing by the specific processing unit 290 of the data processing device 12 in Application Example 2 is realized by the following means.

The present invention provides a server comprising a processor configured to receive audio information or character information from a user terminal, to execute speech recognition processing on the audio information to generate character information, and to record the character information in association with time-series information and speaker information; to execute natural language processing including morphological analysis, syntactic analysis, and calculation of phrase importance on the recorded character information to extract candidate key point information and to generate context information including the candidate key point information and the character information; to generate, under program control, a prompt sentence that includes the context information as input information and that instructs a generative AI model to perform extraction and summarization of key points, to provide the prompt sentence and the context information to the generative AI model, and to obtain key point information and summary information including the candidate key point information from the generative AI model; to format the key point information and the summary information output from the generative AI model as structured data and to generate metadata by associating the structured data with the time-series information and the speaker information; to store the metadata in a remote information storage device together with an identifier and search attribute information such that the metadata is retrievable in response to a subsequent access request; to transmit the metadata acquired in response to the access request to the user terminal such that key points and progress of a conversation are visually presentable at the user terminal; to generate a prompt sentence that instructs an emotion identification model or the generative AI model to perform classification or evaluation of an emotional state based on the context information, to provide the context information and the prompt sentence to the emotion identification model or the generative AI model to extract emotion data, and to store the emotion data in the remote information storage device in association with the key point information and the summary information; and to, when the emotion data indicates a negative emotional state satisfying a predetermined condition, generate a prompt sentence that instructs the generative AI model to generate encouragement information or support proposal information based on the emotion data and the key point information, provide the prompt sentence to the generative AI model to cause the generative AI model to generate positive information, and transmit the generated positive information to the user terminal. This enables the computer system to internally convert raw communication streams into structured, time-aligned, and emotion-aware metadata by means of controlled prompt-based interaction with generative AI models, to persist and index such metadata in a remote storage in a form optimized for retrieval, and to automatically deliver context-appropriate summaries and supportive outputs to user terminals, thereby improving the efficiency, consistency, and responsiveness of communication processing performed by the computer.

The term “processor” refers to a hardware or virtual computation unit, such as a central processing unit or a processing core in a server, configured to execute instructions of one or more programs to perform the operations described in the claims.

The term “user terminal” refers to an information processing apparatus, such as a client device, that acquires audio information or character information from a user and communicates the information with the server over a communication network.

The term “audio information” refers to digital data representing sound acquired by an input device of the user terminal, such as a microphone, and including spoken utterances in one or more languages.

The term “character information” refers to digital data representing textual content, including characters, symbols, and punctuation, obtained either directly from user input or generated by converting audio information through speech recognition.

The term “speech recognition processing” refers to a computational procedure in which the processor analyzes audio information and outputs corresponding character information by mapping acoustic signals to linguistic units.

The term “time-series information” refers to data indicating temporal positions or intervals, such as timestamps or time indices, associated with segments of character information or audio information.

The term “speaker information” refers to data that identifies or distinguishes speakers, such as a speaker label, user identifier, or speaker segment index corresponding to portions of the character information or audio information.

The term “natural language processing” refers to a set of computational techniques for analyzing and processing human language text, including operations such as tokenization, morphological analysis, syntactic analysis, semantic analysis, and information extraction.

The term “morphological analysis” refers to a natural language processing operation in which the processor decomposes text into basic units, such as words or morphemes, and assigns grammatical attributes, such as part-of-speech tags, to the units.

The term “syntactic analysis” refers to a natural language processing operation in which the processor determines structural relationships among words or phrases in a sentence, such as dependency relations or phrase structures.

The term “phrase importance” refers to a quantitative or qualitative measure indicating the relative significance of a word sequence or phrase within given character information, calculated by the processor using one or more importance estimation methods.

The term “candidate key point information” refers to information units, such as sentences, phrases, or extracted features, that are estimated by the processor to potentially represent important content within the character information prior to final key point determination.

The term “context information” refers to a collection of data including at least part of the character information and the candidate key point information, and optionally associated metadata, that is provided as input to a generative AI model or an emotion identification model.

The term “generative AI model” refers to a machine learning model that processes input text and generates new text or structured outputs, such as summaries, key points, or messages, based on learned patterns of natural language.

The term “prompt sentence” refers to a text string generated under program control that specifies a task or instruction for the generative AI model or the emotion identification model and is provided together with context information as input to such a model.

The term “key point information” refers to information representing important elements, such as decisions, tasks, issues, or conclusions, extracted or refined by the processor from communication content, including results output by a generative AI model.

The term “summary information” refers to information that condenses or abstracts original character information into a shorter representation while preserving main meanings or topics, including summaries generated by a generative AI model.

The term “structured data” refers to data organized according to a predefined schema or format, such as field-value pairs or hierarchical records, enabling efficient machine processing, searching, and indexing.

The term “metadata” refers to data that describes or annotates other data, and in the present invention includes at least structured data derived from key point information and summary information and associations with time-series information and speaker information.

The term “remote information storage device” refers to a storage subsystem accessible via a communication network, such as a networked storage service or a cloud-based storage system, configured to store metadata and related information persistently.

The term “identifier” refers to data that uniquely or distinctively identifies a unit of stored metadata, such as a session identifier, object identifier, or record key.

The term “search attribute information” refers to data associated with metadata that facilitates retrieval, such as keywords, tags, indices, or classification labels used in search or filtering operations.

The term “access request” refers to a request issued by the user terminal or another client entity to obtain stored metadata or related information from the remote information storage device or from the server.

The term “visually presentable” refers to being capable of being rendered on a display device of the user terminal, such as in text, graphical, or tabular form, so that a user can perceive the displayed key points and progress of a conversation.

The term “emotion identification model” refers to a computational model, implemented by software or hardware, configured to classify, estimate, or otherwise evaluate an emotional state based on input data such as character information or context information.

The term “emotional state” refers to an internal condition of a user or speaker, such as positive, negative, neutral, or more detailed emotional categories, inferred from communication content or related signals.

The term “emotion data” refers to data representing the result of an evaluation or classification of an emotional state, including numerical scores, categorical labels, or descriptive indicators produced by the emotion identification model or the generative AI model.

The term “negative emotional state” refers to an emotional state indicating at least one of dissatisfaction, anxiety, sadness, anger, or other non-positive conditions as determined by the emotion identification model or the generative AI model.

The term “predetermined condition” refers to a rule or threshold defined in advance, such as a particular emotion label or score range, used by the processor to decide whether the emotion data should trigger generation of positive information.

The term “encouragement information” refers to information generated by the generative AI model that is intended to provide support, reassurance, or motivation to a user experiencing a negative emotional state.

The term “support proposal information” refers to information generated by the generative AI model that suggests specific actions, options, or assistance to address issues related to a user's communication or emotional state.

The term “positive information” refers to information, including encouragement information or support proposal information, that is generated to improve or mitigate a negative emotional state and to enhance a user's experience during interaction with the system.

In one embodiment, a server executes a program that implements the functions of the processor described in the claims. The server comprises at least one hardware processor, a main memory, a nonvolatile storage device, and a network interface, and operates under control of an operating system such as a general-purpose server operating system. The server communicates with one or more user terminals over a communication network such as a local area network or a wide area network.

A user terminal comprises a computation unit, a memory, an audio input device such as a microphone, a display device, and a communication interface. The user terminal runs a client application that acquires audio information or character information from a user and transmits such information to the server. In some embodiments, the user terminal includes a head-mounted display, a vehicle-mounted display, or a handheld display, so that the user can view key point information and summary information while performing tasks in a physical environment.

The server receives audio information and character information from the user terminal by using a network communication protocol such as HTTP or a web socket protocol. The server stores the received information in a buffer in main memory and also in a temporary data store in the nonvolatile storage device. The server associates each piece of received information with a session identifier, a terminal identifier, and a reception timestamp generated by a high-resolution clock.

The server executes speech recognition processing on audio information to generate character information. The server can use an external speech recognition service, such as a cloud-based speech recognition application, by invoking an application programming interface. The server transmits audio samples in a digital audio format, such as linear PCM at 16 kHz, to the speech recognition service and receives a transcription result. The speech recognition service internally uses an acoustic model and a language model, for example a deep neural network acoustic model and an n-gram or neural language model, but the server treats the service as a black box that outputs character information and word-level time alignment information. The server stores the output character information, time alignment, and recognition confidence scores in a transcription log table in a database.

The server records character information in association with time-series information and speaker information. The server assigns time-series information to each token or sentence based on the reception timestamp and the speech recognition time alignment. The server derives speaker information either from metadata supplied by the user terminal or by invoking a speaker diarization module. The diarization module computes audio features such as Mel-frequency cepstral coefficients and applies clustering to segment the audio into speaker-specific segments. The server stores, in a structured data store, a record that includes for each sentence: a sentence identifier, a session identifier, a start time, an end time, a speaker label, and the sentence text.

The server executes natural language processing on the recorded character information. The server uses an open-source natural language processing library such as a tokenization and parsing library to perform morphological analysis and syntactic analysis. The server loads language-specific models, which may consist of neural network-based taggers and parsers, and applies them to each sentence to obtain tokens, lemma forms, part-of-speech tags, and dependency relations. The server stores the analysis results in an annotation table that includes, for each token, a token identifier, the parent sentence identifier, the part-of-speech tag, the dependency relation, and the lemma.

The server calculates phrase importance values as part of the natural language processing. The server constructs a term-document matrix for tokens and n-grams across the recorded character information for a session or for a sliding time window. The server computes, for each term, a term frequency-inverse document frequency value. The server can also compute additional scores such as position-based scores, where earlier mentions receive a higher weight, or semantic similarity scores to domain-specific keyword lists. The server defines a phrase importance value as a weighted combination of these scores and stores the values in a phrase importance table.

The server extracts candidate key point information based on the phrase importance values and the syntactic analysis results. The server identifies phrases that correspond to particular syntactic patterns, such as verb-object pairs or subject-verb-object triples, and that contain tokens whose importance values exceed a threshold. The server sums or aggregates importance values across such structures and designates the highest scoring structures as candidate key point information. The server generates context information by selecting the original sentences that contain the candidate key point information and by including adjacent sentences within a predefined time window. The server constructs the context information as a sequence of sentences with associated time-series information and speaker information.

The server generates a prompt sentence to instruct a generative AI model. The generative AI model is, in one embodiment, a transformer-based neural network having multiple layers of self-attention, feed-forward sublayers, and layer normalization units. The generative AI model is trained with a language modeling objective, where the model predicts the next token in a sequence, and is optionally fine-tuned on instruction-following data where input sequences include instructions and outputs include responses. During training, the generative AI model minimizes a cross-entropy loss between predicted token distributions and actual tokens, and updates internal weight parameters by backpropagation and stochastic gradient descent or a variant thereof. The generative AI model uses an embedding layer to convert tokens to vectors, a positional encoding scheme to represent token positions, and multiple attention heads to compute weighted sums of embedded tokens.

The server constructs the prompt sentence as plain text that includes an instruction portion and a data portion. The instruction portion specifies the task for the generative AI model. For example, the server may construct a prompt sentence such as:
“Extract the key points from the following meeting transcript and summarize them as bullet points, including decisions, action items, deadlines, and responsible persons. Meeting transcript:”

The server appends the context information after this instruction, separated by a delimiter.

The server may include speaker labels and timestamps in the context information. The server selects the number of sentences in the context information so that the total number of tokens in the prompt sentence and the context information remains below a model-specific limit. If the text exceeds the limit, the server truncates older or less relevant sentences according to their phrase importance values.

The server provides the prompt sentence and the context information to the generative AI model through an application programming interface. The server sends the input as a sequence of tokens and specifies decoding parameters such as maximum output length and sampling temperature. The generative AI model processes the input at each layer by computing attention scores between tokens, multiplying the input by learned weight matrices, applying nonlinear activation functions, and normalizing intermediate activations, thereby generating, at the final layer, a probability distribution over tokens for each output position.

The generative AI model selects tokens either by greedy decoding or by constrained sampling and returns output text that includes key point information and summary information. The server receives the output text and parses it according to an expected format. The server can request the generative AI model to output key points in a specific structure. For example, the server can generate a prompt sentence such as:
“From the following conversation, output the key points in the format ‘Action: . . . ; Owner: . . . ; Deadline: . . . ’. Conversation:”

By doing so, the server obtains an output that is easy to parse into fields. The server uses a parser module to extract field labels and values and to store them as structured data records. Each record may include fields for an action description, an assigned user, a due date, a related resource, and a priority level. The server also associates each record with time-series information and speaker information by matching phrases in the model output with original sentences using string similarity or token overlap metrics.

The server generates metadata by combining the structured data derived from the generative AI model output with the time-series information and the speaker information. The server stores metadata in a database as objects identified by metadata identifiers. Each metadata object includes a session identifier, a list of key points, a summary text, a list of time spans, and a list of speaker labels. The server indexes metadata by search attributes, such as topic keywords, entity names, or time ranges, using an indexing engine such as an inverted index. Because the server stores metadata in a structured form with indices, search operations by later queries are performed using index lookups rather than full-text scans, thereby reducing latency and computation load.

The server stores metadata in a remote information storage device. The remote information storage device can be implemented as a network-attached storage service or a cloud-based object storage system. The server generates an identifier for each metadata object and stores the metadata together with search attribute information, such as tags or keywords. The server stores the metadata in a serialized format, such as a structured text format or a binary format, and records a reference in an index table. By storing the data in the remote information storage device, the system can scale storage independently of the server computation resources.

The server retrieves metadata in response to an access request from the user terminal. The user terminal sends an access request specifying, for example, a session identifier, a time range, or a keyword. The server receives the request and applies it to the index table. The server determines a subset of metadata objects that match the search attributes and reads the corresponding records from the remote information storage device. The server transmits the retrieved metadata to the user terminal. The user terminal renders key point information and summary information on the display, for example as a timeline view that shows key points in temporal order with speaker labels, or as a list of bullet points grouped by topic.

The server generates a prompt sentence that instructs an emotion identification model or the generative AI model to perform classification or evaluation of an emotional state. The server selects context information that is particularly relevant for emotion analysis, such as sentences that contain first-person expressions or sentiment-indicative words. The server may construct a prompt sentence such as:
“Classify the overall emotion of the following user statements as one of: positive, negative, neutral, or urgent, and briefly explain the reason. User statements:”

The server provides the prompt sentence and the context information to the emotion identification model or the generative AI model. In another embodiment, the server uses a dedicated emotion identification model implemented as a neural network. Such a model can be a transformer or recurrent neural network that receives tokenized text and outputs a probability distribution over emotion classes. The model is trained on labeled data, with a loss function such as cross-entropy, and is optimized with gradient-based updates.

The server receives emotion data from the model, which may include a predicted class label and associated confidence scores. The server stores the emotion data in association with the key point information and the summary information by adding emotion fields to the metadata. The server can aggregate emotion data across time to compute trends, such as the proportion of negative emotional states in a meeting or over a sequence of messages. Because the emotion data is stored in structured form and linked with key points, later queries can filter key points by emotional state, which would not be feasible with unstructured logs.

The server determines whether the emotion data indicates a negative emotional state satisfying a predetermined condition. The predetermined condition can specify that a confidence score for a negative or urgent class exceed a threshold for a minimum duration or across a minimum number of user statements. If the condition is met, the server generates a prompt sentence that instructs the generative AI model to generate encouragement information or support proposal information. The server may construct a prompt sentence such as:
“The user said: ‘Recently, my work is not going well.’ Generate a concise, empathetic, and encouraging message in polite language, avoiding promises that cannot be fulfilled.”

The server provides this prompt sentence, optionally along with key point information for context, to the generative AI model. The generative AI model generates positive information such as an empathetic message or a suggestion. The server evaluates the output according to predefined rules, such as content length, absence of disallowed terms, and adherence to guidelines. The server can re-prompt or filter the output if the rules are not satisfied. The server transmits the approved positive information to the user terminal, which displays it to the user in a notification area or as part of a conversation interface.

The system provides technical effects beyond mere automation of human tasks. Because the server converts raw communication streams into structured, time-aligned metadata that includes emotion data, subsequent retrieval operations do not require scanning entire transcripts but use index-based retrieval. This reduces processing time and computational load on the server compared to naive full-text search. Furthermore, by using phrase importance and structural analysis to pre-filter candidate key point information before invoking the generative AI model, the server reduces the input size to the generative AI model, thereby lowering inference time and memory consumption. The combination of rule-based extraction and model-based refinement improves robustness: the server can fall back to candidate key point information if the generative AI model output is inconsistent, which increases reliability compared to a pure model-based approach.

The use of explicit prompt sentences controlled by the server also constitutes a technical improvement. The server defines and manages prompt templates for different tasks and contexts, and adjusts them dynamically in response to conversation characteristics. This enables the server to enforce consistent input structure to the generative AI model and to obtain outputs in structured or semi-structured formats that are easily parsed. By doing so, the server transforms an otherwise opaque text generation process into a predictable component of a data processing pipeline, enabling more efficient downstream processing and error handling.

The emotion analysis integration yields additional technical advantages. Because the server stores emotion data in the same metadata structure as key point information, the server can compute joint statistics and perform compound queries that combine semantic and emotional conditions without separate processing pipelines. This reduces duplication of data and eliminates the need for repeated parsing of original character information. As a result, storage overhead and processing redundancy are reduced. The negative emotion detection and automatic generation of positive information also reduce human operator load in certain use cases, such as contact centers, and provide consistent responses that are generated according to the technical rules embedded in the prompt sentence and model constraints.

The implementation of the generative AI model and the emotion identification model is not limited to a particular architecture. In one variant, the server uses a transformer model with a specified number of layers and attention heads, trained on a corpus of domain-specific communication logs. The server can fine-tune the model by adding a classification head for emotion detection or by conditioning the model on special tokens that represent tasks, such as “[SUMMARIZE]” or “[EMOTION]”. Training uses mini-batches of token sequences, a loss function appropriate to the task (e.g., cross-entropy for classification, negative log-likelihood for language modeling), and an optimizer such as an adaptive gradient method. To reduce overfitting, the server applies regularization techniques such as dropout and data augmentation, for example paraphrasing or random masking of tokens during training. In another variant, the server uses a smaller, task-specific neural network for phrase importance estimation. This network can receive as input word embeddings, position indices, and syntactic features such as dependency relation types, and can output a scalar importance score for each candidate phrase. The network may be trained on annotated data where human annotators have labeled phrases as key points or non-key points. By learning patterns from such data, this module can outperform simple TF-IDF scoring and increase precision in selecting candidate key point information, leading to more accurate and compact context information for the generative AI model.

The system can be applied in various domains where communication processing is connected to real-world equipment or processes. For example, in a factory, the user terminal can be implemented as smart glasses worn by an operator. The user speaks while inspecting a machine, and the terminal sends audio to the server. The server generates key point information that describes faults or tasks and sends it back to the terminal. The operator can view the key points overlaid on the physical scene, and the server can also send control signals to a maintenance management system to schedule work orders. In another domain, in a vehicle, the user terminal can be a vehicle-mounted device that captures passenger speech. The server extracts key point information such as comfort preferences and uses it to adjust in-vehicle conditions by sending commands to climate control or audio systems. These configurations show that the system can coordinate communication processing with physical device control, thereby realizing a technical use beyond information display. Various modifications and alternative configurations are possible. The server may execute all components on a single machine or distribute functions across multiple machines in a cluster. Some preprocessing functions, such as local speech recognition or noise reduction, may be executed on the user terminal. The remote information storage device may be implemented as a distributed file system or as a database cluster. The generative AI model and the emotion identification model may be deployed as local services within the server environment or accessed as external services through secure communication channels. The system can selectively enable or disable modules, such as emotion analysis or positive information generation, depending on application requirements, without departing from the scope described in the claims.

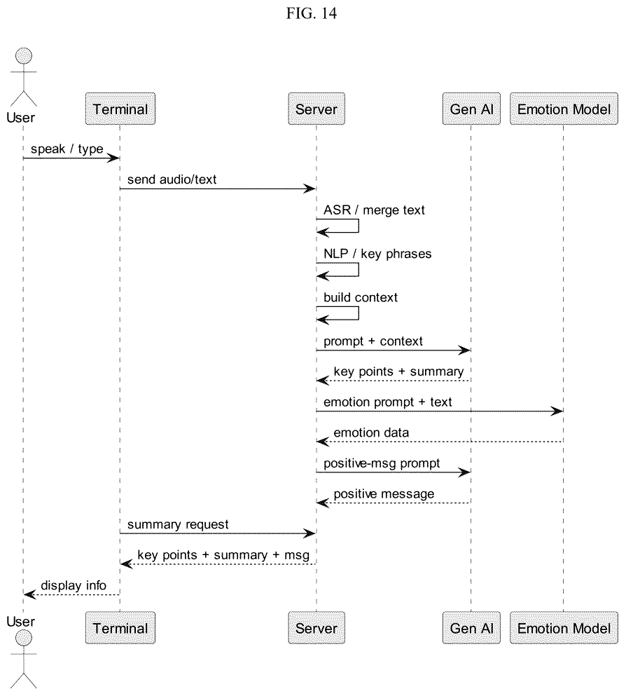

The following describes the processing flow using FIG. 14.

### Step 1

User provides communication content.

User speaks into a microphone of the terminal or inputs text through a keyboard, touch interface, or chat client.

Input: Spoken utterances or typed text from User.

Output: Raw audio signals or raw text data held inside Terminal.

### Step 2

Terminal acquires and preprocesses communication data.

Terminal samples the audio at a fixed rate (for example, 16 kHz), converts it to digital audio frames, and optionally applies noise reduction and voice activity detection to remove silence.

For typed input, Terminal normalizes character encoding and removes control characters.

Terminal labels each data unit with a local timestamp and a session identifier.

Input: Raw audio signals or raw text data from Step 1.

Output: Normalized digital audio data or normalized text data with local timestamps and session identifiers.

### Step 3

Terminal transmits communication data to Server.

Terminal packages the normalized audio or text into a network message, includes metadata such as user identifier, terminal identifier, and session identifier, and sends the message to

Server over a network protocol. Terminal may segment long audio into fixed-duration chunks and send them sequentially.

Input: Normalized digital audio data or text data from Step 2.

Output: Network packets containing audio or text payloads received by Server.

### Step 4

Server receives and buffers communication data.

Server accepts incoming network requests, verifies message formats, and stores the payloads in an input buffer in memory. Server assigns server-side timestamps, validates session identifiers, and writes a log entry to a temporary storage area for each received chunk.

Input: Network packets with audio or text payloads from Step 3.

Output: Buffered audio frames or text segments stored with server timestamps and verified session identifiers.

### Step 5

Server performs speech recognition on audio data.

Server detects whether a payload is audio. For audio data, Server sends it to a speech recognition component or external speech recognition service. Server passes audio frames and recognition configuration (language code, sample rate, punctuation option) to the recognizer, receives a transcription, and aligns recognized words with time offsets.

Input: Buffered audio frames with metadata from Step 4.

Output: Character information (transcript text), word-level time alignment, and recognition confidence scores.

### Step 6

Server consolidates text data with time-series and speaker information.

Server merges text obtained from speech recognition with text directly received from Terminal. Server associates each sentence with time-series information based on alignment data and server timestamps, and associates speaker information using speaker identifiers in metadata or a speaker diarization module.

Input: Transcribed text from Step 5 and directly received text from Step 4.

Output: Time-stamped, speaker-labeled sentences stored as character information records.

### Step 7

Server performs natural language preprocessing.

Server tokenizes each sentence into words, applies morphological analysis to derive lemmas and part-of-speech tags, and executes syntactic parsing to identify dependency relations.

Server writes token-level records containing sentence identifiers, tokens, lemmas, part-of-speech tags, and dependency roles to an annotation store.

Input: Character information records from Step 6.

Output: Annotated tokens and sentence structures with grammatical and dependency information.

### Step 8

Server computes phrase importance scores.

Server constructs a term-document structure for tokens and n-grams across a session or time window. Server calculates term frequency and inverse document frequency for each term and may compute additional position-based or domain-specific weights. Server combines these values into an importance score for each phrase and stores the scores with references to the corresponding tokens and sentences.

Input: Annotated tokens and sentence structures from Step 7.

Output: Phrase importance scores linked to tokens, phrases, and sentences.

### Step 9

Server selects candidate key point information.

Server examines phrases and sentences and selects units where importance scores exceed a threshold and syntactic patterns match criteria (such as action phrases or decision statements).

Server groups tokens into candidate key point phrases and records these as candidate key point information with associated scores and locations.

Input: Phrase importance scores and annotated text from Step 8.

Output: Candidate key point information objects referencing specific sentences and token ranges.

### Step 10

Server constructs context information.

Server selects sentences that contain candidate key point information and includes neighboring sentences before and after within a predefined time window. Server orders these sentences chronologically and aggregates them into context information for a session or segment.

Input: Candidate key point information from Step 9 and sentence records from Step 6.

Output: Context information blocks composed of ordered sentences, with time-series and speaker metadata.

### Step 11

Server generates a prompt sentence for key point extraction and summarization.

Server analyzes context information and determines a task type (for example, factory maintenance, meeting, customer support). Server constructs a prompt sentence that explicitly instructs a generative AI model to extract and summarize key points. For example, Server may generate:
“Extract the key points from the following meeting transcript and summarize them as bullet points, including decisions, action items, deadlines, and responsible persons. Meeting transcript:”

Server concatenates this instruction with the context information, separated by a delimiter.

Input: Context information blocks from Step 10.

Output: Prompt sentence text and combined prompt-plus-context text for the generative AI model.

### Step 12

Server submits prompt and context to the generative AI model.

Server tokenizes the combined text and sends it to a generative AI model through an application programming interface. Server sets inference parameters such as maximum output length, sampling strategy, and temperature. The generative AI model applies its transformer layers, attention mechanisms, and learned parameters to compute output token probabilities and then decodes these into output text.

Input: Prompt-plus-context text from Step 11.

Output: Generated text containing refined key point information and summary information.

### Step 13

Server parses generative AI model output into structured key points and summaries.

Server inspects the generated text and extracts individual key points and summary segments according to an expected format, such as bullet points or labeled fields. Server uses pattern matching or lightweight parsing to isolate action descriptions, responsible parties, deadlines, and other attributes.

Input: generated text from Step 12.

Output: Structured key point information records and summary information records.

### Step 14

Server aligns structured outputs with original time-series and speaker information.

Server matches key point phrases in the structured records with original sentences using token overlap or similarity measures. Server associates each structured key point with time intervals and speaker labels from the matched sentences.

Input: Structured key point information from Step 13 and sentence records from Step 6.

Output: Time-aligned, speaker-labeled structured key point objects.

### Step 15

Server generates metadata objects.

Server combines structured key point information, summary information, time-series information, and speaker information into metadata objects. Each metadata object includes identifiers, lists of key points, summary text, time spans, speaker labels, and search attributes such as topics or tags derived from tokens.

Input: Time-aligned key point objects from Step 14 and summary records from Step 13.

Output: Metadata objects ready for persistent storage and indexing.

### Step 16

Server stores metadata in a remote information storage device and updates indices.

Server serializes metadata objects into a storage format and sends them to a remote information storage device. Server receives storage identifiers and records these in an index, together with search attributes such as keywords, session identifiers, and timestamps.

Input: Metadata objects from Step 15.

Output: Persistently stored metadata in the remote storage and updated index entries.

### Step 17

Server generates a prompt sentence for emotion analysis.

Server selects context information focused on user statements, especially those with emotional content. Server constructs a prompt sentence instructing an emotion identification model or generative AI model to classify emotional state. For example, Server may generate:
“Classify the overall emotion of the following user statements as one of: positive, negative, neutral, or urgent, and briefly explain the reason. User statements:”

Server appends the selected statements after the instruction.

Input: Context information and sentence records from Step 10 and Step 6.

Output: Emotion-analysis prompt sentence and associated text content.

### Step 18

Server performs emotion classification.

Server sends the emotion-analysis prompt and context to an emotion identification model or to the generative AI model via an application programming interface. The model processes the input and outputs emotion data, such as a label and confidence scores for each emotion category.

Input: Emotion-analysis prompt and context text from Step 17.

Output: Emotion data indicating emotional state classifications and confidence values.

### Step 19

Server associates emotion data with key points and summaries.

Server links emotion data to specific sentences or time ranges and then to the corresponding key point records and summary segments. Server augments metadata objects by adding emotion fields such as dominant emotion label, urgency level, and aggregated sentiment metrics.

Input: Emotion data from Step 18 and metadata objects from Step 15.

Output: Emotion-enriched metadata objects with combined semantic and emotional annotations.

### Step 20

Server evaluates emotion data against predetermined conditions.

Server compares emotion labels and confidence scores with predetermined thresholds or rules. Server determines whether a negative or urgent emotional state is present for a specified duration or across a minimum number of statements.

Input: Emotion-enriched metadata objects from Step 19 and stored conditions.

Output: Decision flags indicating whether conditions for generating positive information are satisfied.

### Step 21

Server generates a prompt sentence for positive information.

When conditions are satisfied, Server selects representative user statements and relevant key point information. Server constructs a prompt sentence instructing the generative AI model to generate encouragement information or support proposal information. For example, Server may generate:
“The user said: ‘Recently, my work is not going well.’ Based on this, generate a concise, empathetic, and encouraging message in polite language, avoiding promises that cannot be fulfilled.”

Input: Decision flags from Step 20, selected user statements, and key point information from Step 13 and Step 14.

Output: Positive-information prompt sentence and associated context text.

### Step 22

Server generates positive information using the generative AI model.

Server sends the positive-information prompt and context to the generative AI model. The model processes the input and outputs a candidate positive message. Server receives the generated text and checks it against predefined constraints for length, prohibited terms, and style.

Input: Positive-information prompt sentence and context text from Step 21.

Output: Candidate positive information text generated by the model.

### Step 23

Server filters and finalizes positive information.

Server applies rule-based checks to the candidate positive information, such as verifying that no disallowed phrases appear and that the message meets formatting requirements. If the candidate fails, Server may adjust the prompt and repeat generation. Once accepted, Server marks the text as final positive information.

Input: Candidate positive information text from Step 22.

Output: Approved positive information text ready for delivery to Terminal.

### Step 24

Terminal requests and receives summaries and metadata.

User initiates a request for a summary, key points, or emotional overview through the Terminal application. Terminal sends a query specifying session identifiers, time ranges, or keywords. Server receives the query, uses the index to find metadata, and returns the corresponding metadata objects and any positive information. Terminal receives these data via the network interface.

Input: User query from User and metadata stored in the remote storage from Step 16 and Step 19, as accessed by Server.

Output: Metadata objects, summaries, key points, emotional annotations, and positive information delivered to Terminal.

### Step 25

Terminal displays key points, summaries, and positive information to User.

Terminal parses the received metadata, constructs user interface elements such as lists, timelines, or overlays, and renders key points and summaries on the display. Terminal also highlights emotional states and may show positive information messages in a notification area.

Input: Metadata and positive information from Step 24.

Output: Visual presentation of conversation key points, summaries, and emotion-aware messages to User.

### Step 26

User reviews information and optionally continues communication.

User reads the displayed key points and summaries and, if necessary, continues communication by speaking or typing additional content. Terminal captures the new communication and returns to Step 1, allowing the pipeline to process new data and to update stored metadata incrementally.

Input: Visualized information from Step 25 and new user interactions.

Output: Updated communication data that re-enters the processing pipeline for further analysis and storage.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

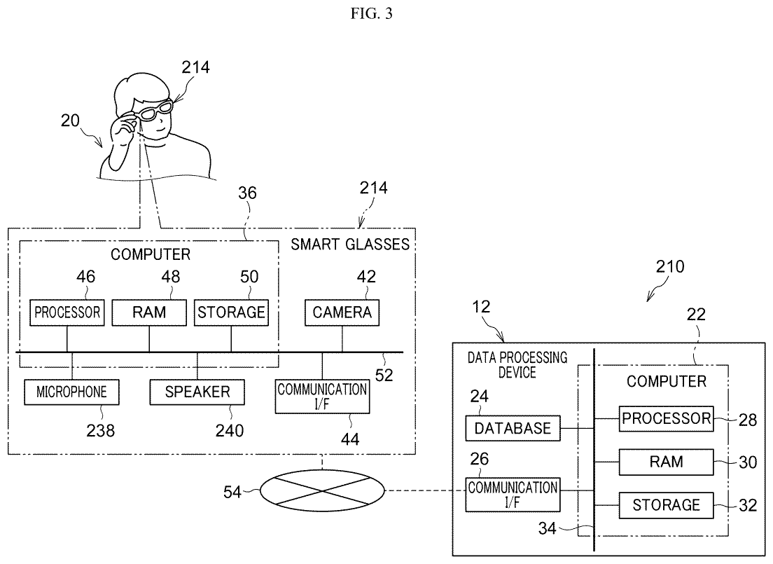

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

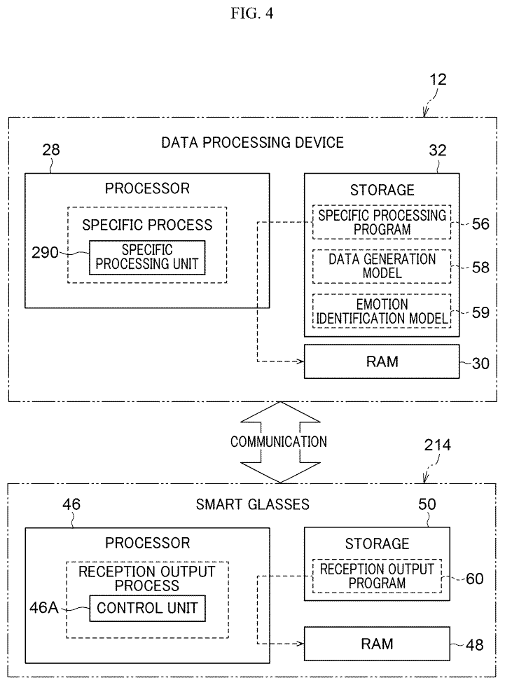

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

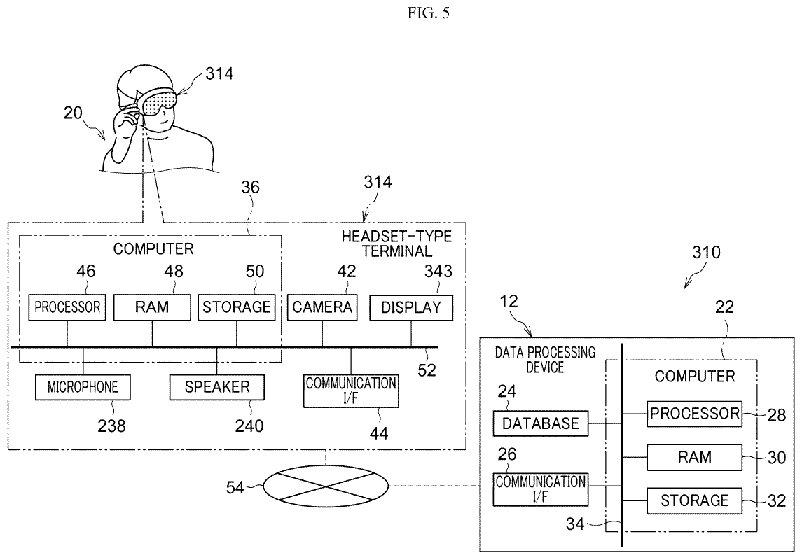

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

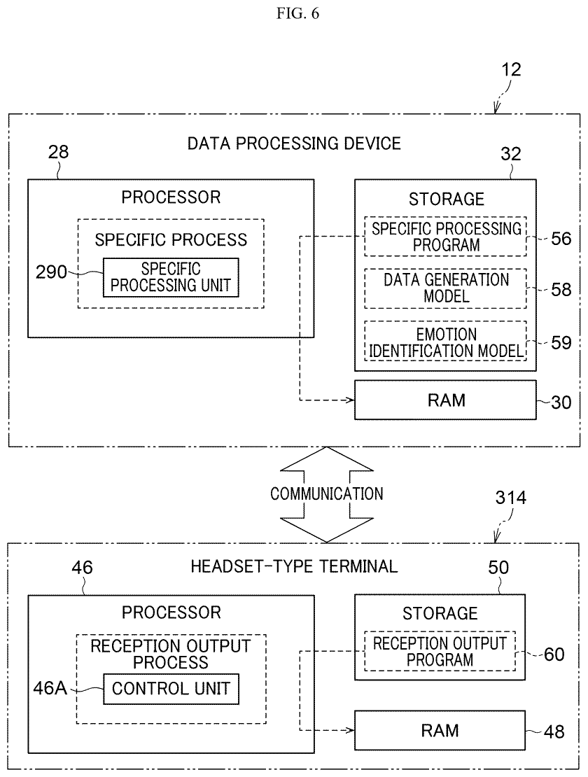

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

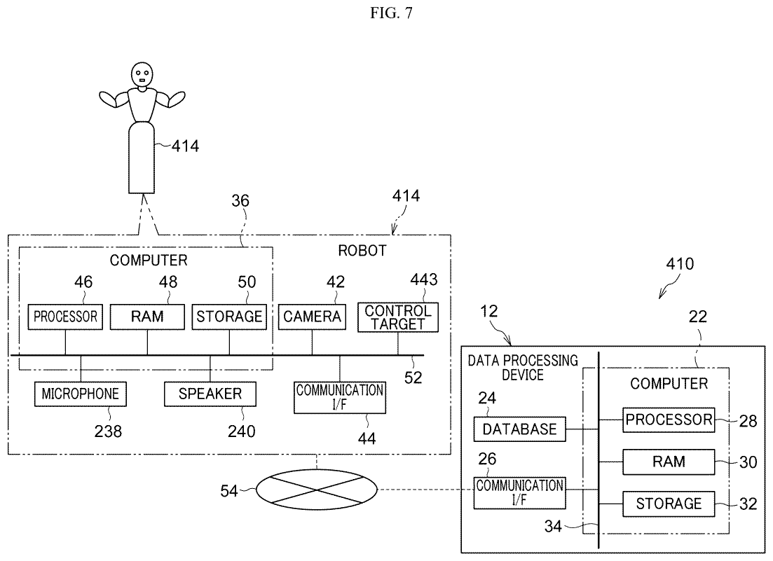

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

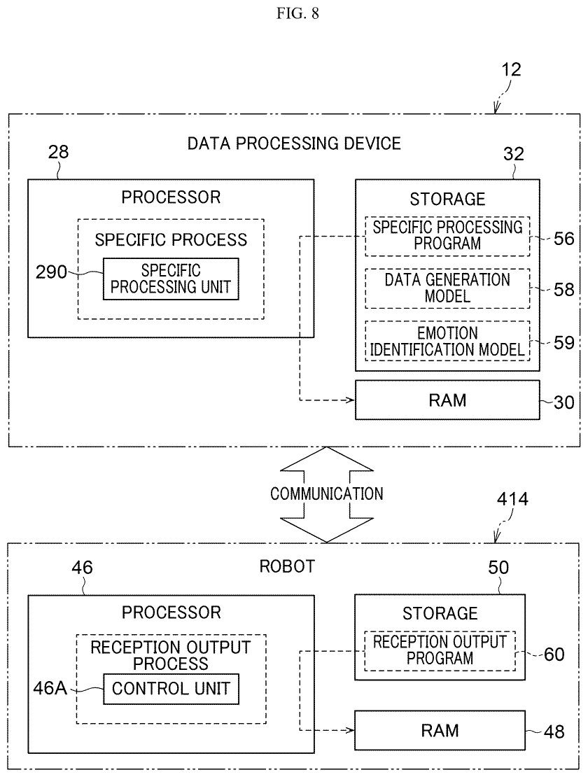

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

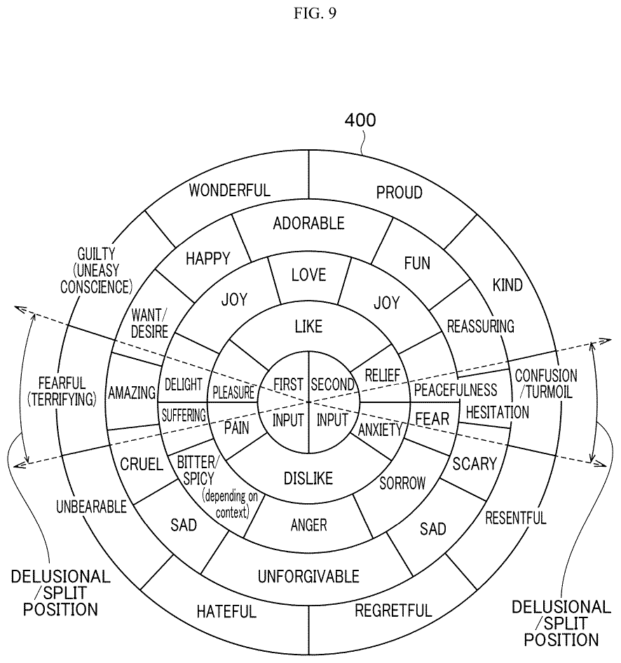

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

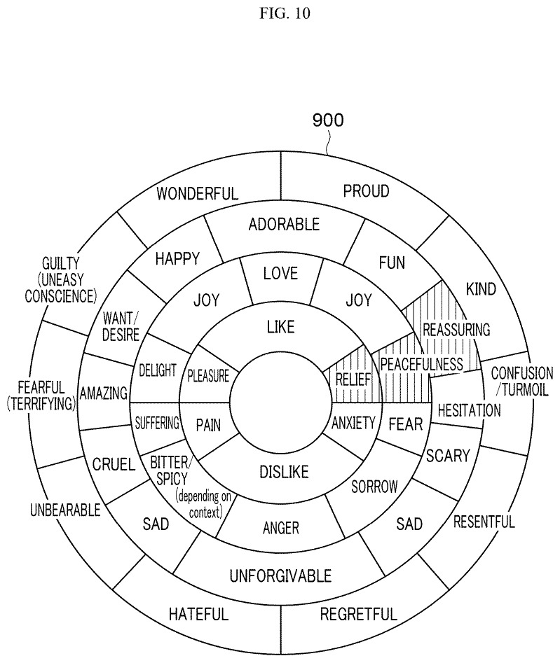

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, a storage device, a user terminal, and a network interface,
wherein the processor is configured to
receive communication information from the user terminal via the network interface and store the communication information as record information in the storage device,
analyze text information included in the record information as input information by using a
generative AI model and a natural language processing algorithm, and extract summary information as key points based on the analysis, the summary information including at least date information, actor information, deadline information, and action information,
aggregate the extracted summary information into reference information in a list format or a structured data format by performing classification processing, duplicate-elimination processing, and format-adjustment processing on the summary information based on a prompt sentence given to the generative AI model,
store the reference information as an electronic file in a network storage area provided by an external storage service, and associate and manage identification information and reference location information corresponding to the electronic file in the storage device, and
generate browsing screen information that enables a user, at a later time point, to view the reference information based on the identification information and the reference location information, and transmit the browsing screen information to the user terminal.

### (Supplementary 2)

The system according to supplementary 1,
wherein the processor is configured to
extract emotional attribute data representing an emotional state from the text information included in the record information by using the generative AI model, and store the emotional attribute data in association with the summary information in the storage device and in the network storage area.

### (Supplementary 3)

The system according to supplementary 1,
wherein the processor is configured to
generate a prompt sentence that provides the emotional attribute data as input information to the generative AI model, cause the generative AI model to generate response information having affirmative content corresponding to the emotional attribute data based on the prompt sentence, and provide the response information to the user terminal.

### Application Example 1

### (Supplementary 1)

A system comprising a processor,
wherein the processor is configured to
receive communication information acquired from a user terminal and analyze the communication information by using a generative AI model and a natural language processing algorithm to extract key point information related to work instructions or notification matters,
generate a prompt sentence that instructs the generative AI model to integrate the key point information, remove duplication, and simplify expressions, and operate the generative AI model with the prompt sentence and the key point information as inputs to generate summary information for shift handover or work viewing,
convert the key point information and the summary information into a structured data format associated with metadata including an identifier, time information, and user information, store the structured data format in a cloud-type storage device, and make the summary information referable to a subsequent user via the cloud-type storage device, and
acquire the summary information in response to a viewing request for the summary information stored in the cloud-type storage device and provide the summary information to the user terminal so as to improve efficiency of information sharing and work communication among workers in a real environment.

### (Supplementary 2)

The system according to supplementary 1,
wherein the processor is configured to dynamically change the prompt sentence input to the generative AI model according to a type of the target communication information, an attribute of a work place, or a role of a user, and to control an output format, a level of detail, and a style of expression of the key point information and the summary information, thereby generating work summaries optimized for different user groups.

### (Supplementary 3)

The system according to supplementary 1,
wherein the processor is configured to acquire, based on an operation from the user terminal,
a plurality of pieces of communication information selected by a user or key point information stored in the cloud-type storage device, generate a prompt sentence using the acquired information as input, and send the prompt sentence to the generative AI model to generate, on demand, additional summary information for progress reporting or for a supervisor, and store the additional summary information in the cloud-type storage device to enable reuse of the additional summary information.

### Example 2

### (Supplementary 1)

A system comprising a processor,
wherein the processor is configured to
acquire communication information transmitted from a user terminal, and record the communication information in a storage device as structured data including identification information and time information,
acquire, from the storage device, communication information exchanged among multiple users, and analyze the communication information by using a generative AI model as a natural language processing technique to extract key-point information including at least a conversation progress, decision items, task items, responsible entities, and deadlines,
generate a prompt sentence that instructs classification and summarized output of the key-point information, input the prompt sentence and the key-point information into the generative AI model, and convert the key-point information into structured key-point information based on an output from the generative AI model,
store the structured key-point information in a remote storage device in a format that is referable by a later-participating user, and maintain, in association in the storage device, reference information indicating the structured key-point information stored in the remote storage device, and
accept, from the user terminal, a request to acquire the structured key-point information stored in the remote storage device, acquire the structured key-point information from the remote storage device, and convert the structured key-point information into display data transmittable to the user terminal.

### (Supplementary 2)

The system according to supplementary 1,
wherein the processor is configured to
set the prompt sentence input to the generative AI model so as to instruct an output format of the key-point information as structured data including at least one of information indicating the conversation progress, the decision items, next action items, the responsible entities, and
the deadlines, and control the generative AI model such that only the key-point information output in the structured data format is stored in the remote storage device.

### (Supplementary 3)

The system according to supplementary 1,
wherein the processor is configured to
automatically extract, from the storage device, a communication information set corresponding to a conversation unit based on a predetermined time condition or a predetermined record-number condition, and, for each communication information set,
automatically execute generation of the prompt sentence for the generative AI model,
extraction of the key-point information, and storage of the structured key-point information in the remote storage device.

### Application Example 2

### (Supplementary 1)

A system comprising a processor,
wherein the processor is configured to
receive audio information or character information acquired from a user terminal, execute speech recognition processing on the audio information to generate character information, and record the character information in association with time-series information and speaker information; and
execute natural language processing including morphological analysis, syntactic analysis, and calculation of phrase importance on the recorded character information to extract candidate key point information and to generate context information including the candidate key point information and the character information; and
generate a prompt sentence that includes the context information as input information and instructs a generative AI model to perform extraction and summarization of key points, provide the prompt sentence and the context information to the generative AI model, and obtain key point information and summary information including the candidate key point information from the generative AI model; and
format the key point information and the summary information output from the generative AI model as structured data and generate metadata by associating the structured data with the time-series information and the speaker information; and
store the metadata in a remote information storage device together with an identifier and search attribute information such that the metadata is retrievable in response to a subsequent access request; and transmit the metadata acquired in response to the access request to the user terminal such that key points and progress of a conversation are visually presentable at the user terminal.

### (Supplementary 2)

The system according to supplementary 1,
wherein the processor is configured to
generate a prompt sentence that instructs an emotion identification model or the generative AI model to perform classification or evaluation of an emotional state based on the context information, provide the context information and the prompt sentence to the emotion identification model or the generative AI model to extract emotion data, and store the emotion data in the remote information storage device in association with the key point information and the summary information.

### (Supplementary 3)

The system according to supplementary 1,
wherein the processor is configured to
determine that the emotion data indicates a negative emotional state satisfying a predetermined condition, generate a prompt sentence that instructs the generative AI model to generate encouragement information or support proposal information based on the emotion data and the key point information, provide the prompt sentence to the generative AI model to cause the generative AI model to generate positive information, and transmit the generated positive information to the user terminal.

What is claimed is:

1. A system comprising:
circuitry configured to:
receive, via a communication interface coupled to a packet-switched network, communication information from a user terminal and store the communication information as record information in a storage device;
analyze text information included in the record information using a generative AI model and a natural language processing algorithm, and extract summary information comprising key points including at least date information, actor information, deadline information, and action information;
aggregate the extracted summary information into reference information in a structured data format by performing classification processing, duplicate-elimination processing, and format-adjustment processing on the summary information based on a prompt sentence supplied to the generative AI model;
store the reference information as an electronic file in a network-based storage area and associate identification information and reference location information corresponding to the electronic file in the storage device; and
generate browsing screen information that enables the user to view the reference information based on the identification information and the reference location information, and transmit the browsing screen information to the user terminal via the communication interface.

2. The system according to claim 1, wherein the circuitry is configured to extract emotional attribute data representing an emotional state of the user from the text information included in the record information using the generative AI model, and store the emotional attribute data in association with the summary information in the storage device.

3. The system according to claim 2, wherein the circuitry is configured to generate a prompt sentence that provides the emotional attribute data as input to the generative AI model, cause the generative AI model to generate response information having affirmative content corresponding to the emotional attribute data, and transmit the response information to the user terminal via the communication interface.

4. The system according to claim 3, wherein the circuitry is configured to dynamically change the prompt sentence input to the generative AI model according to at least one of a type of the target communication information, an attribute of a context, or a role of the user, and control an output format, a level of detail, and a style of expression of the summary information.

5. The system according to claim 4, wherein the circuitry is configured to acquire, in response to an operation from the user terminal, a plurality of pieces of communication information or summary information stored in the network-based storage area, generate a prompt sentence using the acquired information as input, and cause the generative AI model to generate additional summary information on demand.

6. The system according to claim 1, wherein the circuitry is configured to convert the key point information and the summary information into a structured data format associated with metadata comprising an identifier, time information, and user information, and store the structured data format in the network-based storage area.

7. The system according to claim 6, wherein the circuitry is configured to generate a search index for the structured data format based on the metadata, and enable retrieval of the reference information by querying the search index based on at least one of the identifier, time information, or user information.

8. The system according to claim 1, wherein the natural language processing algorithm applied to the text information comprises tokenization, dependency parsing, and semantic role labeling to identify and extract the actor information, deadline information, and action information as structured fields.

9. The system according to claim 1, wherein the circuitry is configured to analyze the text information using the generative AI model by encoding the text information as a token sequence and applying attention-based processing to identify salient spans corresponding to the key points.

10. The system according to claim 9, wherein the circuitry is configured to compute a confidence score for each extracted key point, and filter out key points having a confidence score below a predetermined threshold prior to aggregation.

11. The system according to claim 1, wherein the circuitry is configured to apply duplicate-elimination processing to the extracted summary information by computing pairwise similarity scores between key points and merging key points having a similarity score exceeding a predetermined threshold.

12. The system according to claim 1, wherein the circuitry is configured to periodically update the reference information stored in the network-based storage area by reprocessing newly received record information, and update the identification information and reference location information in the storage device to reflect the updated reference information.

13. The system according to claim 1, wherein the reference information is stored in the network-based storage area in at least one of a list format and a structured data format that is accessible via a standardized interface.

14. The system according to claim 1, wherein the circuitry is configured to receive a viewing request for the reference information from a second user terminal, retrieve the reference information from the network-based storage area based on the identification information and the reference location information, and transmit the reference information to the second user terminal.

15. The system according to claim 14, wherein the circuitry is configured to apply an access control check before transmitting the reference information to the second user terminal, and deny access when the second user terminal does not satisfy a predetermined authorization condition.

16. The system according to claim 1, wherein the circuitry is configured to record an execution log comprising the prompt sentence and the corresponding reference information for each invocation of the generative AI model, and store the execution log in the storage device.

17. The system according to claim 16, wherein the circuitry is configured to compare a newly generated summary information against a prior summary information stored in the execution log, compute a change detection score, and notify the user terminal when the change detection score exceeds a predetermined threshold.

18. A system comprising:
circuitry configured to:
receive communication information from a user terminal via a communication interface and store the communication information as record information in a storage device;
apply a generative AI model and a natural language processing algorithm to text information included in the record information to extract key point information and aggregate the key point information into structured reference information; and
store the reference information in a network-based storage area with associated identification information and reference location information, extract emotional attribute data from the text information, and generate browsing screen information enabling retrieval of the reference information and the emotional attribute data at the user terminal.

19. The system according to claim 18, wherein the circuitry is configured to generate a prompt sentence providing the emotional attribute data as input to the generative AI model, cause the generative AI model to generate response information with affirmative content, and transmit the response information to the user terminal.

20. A method comprising:
receiving, via a communication interface coupled to a packet-switched network, communication information from a user terminal and storing the communication information as record information in a storage device;
analyzing text information included in the record information using a generative AI model and a natural language processing algorithm, and extracting summary information comprising key points including at least date information, actor information, deadline information, and action information;
aggregating the extracted summary information into reference information in a structured data format by performing classification processing, duplicate-elimination processing, and format-adjustment processing on the summary information based on a prompt sentence supplied to the generative AI model;
storing the reference information as an electronic file in a network-based storage area and associating identification information and reference location information corresponding to the electronic file in the storage device; and
generating browsing screen information that enables the user to view the reference information based on the identification information and the reference location information, and transmitting the browsing screen information to the user terminal via the communication interface.
